(19) United States
(12) Patent Application Publication
(10) Pub. No.: US 2010/0103088 A1
(43) Pub. Date: Apr. 29, 2010

(54) SOLID-STATE LASER APPARATUS, DISPLAY APPARATUS AND WAVELENGTH CONVERTING ELEMENT

(76) Inventors: Toshifumi Yokoyama, Osaka (JP); Kazuhisa Yamamoto, Osaka (JP); Hiroyuki Furuya, Nara (JP); Kiminori Mizuuchi, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/524,820

(22) PCT Filed: Jan. 18, 2008
(86) PCT No.: PCT/JP2008/050583

§ 371 Date: Jul. 28, 2009

(30) Foreign Application Priority Data
Jan. 29, 2007 (JP) 2007-017573
Mar. 1, 2007 (JP) 2007-050998
Mar. 16, 2007 (JP) 2007-068397

(51) Int. Cl. G09G 3/36; H01S 3/10; H01S 3/109

(52) U.S. Cl. 345/102; 372/26; 372/22

(57) ABSTRACT

A solid-state laser apparatus includes: a semiconductor laser light source for emitting laser light; an optical resonator having a solid-state laser medium to be excited by incidence of the laser light to oscillate fundamental laser light, and a mirror; and a quasi phase matching wavelength converting element, disposed in the optical resonator, for converting a wavelength of the fundamental laser light, wherein the quasi phase matching wavelength converting element is formed with a polarization inversion region having a predetermined cycle, and the length of the polarization inversion region in an optical axis direction is 1.0 mm or less.

### TECHNICAL FIELD

The present invention relates to a solid-state laser apparatus, a display apparatus, and a wavelength converting element, and more specifically to a solid-state laser apparatus capable of obtaining a stable output by suppressing lowering of wavelength conversion efficiency resulting from a temperature change, a display apparatus incorporated with the solid-state laser apparatus, and a wavelength converting element to be used in the solid-state laser apparatus.

### BACKGROUND ART

In an optical disc device, a laser printer, or a like device, a semiconductor laser light source including a blue laser has been frequently used. As a high-output semiconductor laser light source has been demanded, application to a projection display apparatus or application to a backlight device in a liquid crystal display apparatus has been studied. A high-output light source capable of stably emitting red light (R light), green light (G light), and blue light (B light) of three primary colors has been demanded in the applications.

In view of the above, development of a high-output semiconductor laser light source has progressed. In addition to the above, development of a solid-state laser apparatus for converting fundamental light oscillated by excitation of a solid-state laser medium into harmonic has been actively performed. This is because a solid-state laser apparatus to be excited by a semiconductor laser is advantageous in miniaturization as well securing high efficiency, since the spectral bandwidth of an excitation light source is narrow, and use of a wavelength converting element enables to emit large-output G light and B light.

For instance, as a first conventional example, there is proposed a laser light emitting module capable of extracting laser light having a shorter wavelength than red light with stable output (see e.g. patent document 1). The laser light emitting module includes a solid-state laser medium, a wavelength converting element for converting the wavelength of light emitted from the solid-state laser medium, a resonator constituted of a pair of resonating reflectors for reciprocating light, with the solid-state laser medium and the wavelength converting element being interposed therebetween, a semiconductor laser light source for emitting light for exciting the solid-state laser medium, and a window cap formed with a window portion for extracting light emitting from the resonator. The laser light emitting module is further provided with a heat sink in contact with the semiconductor laser light source and a base member, and the base member for holding the resonator to suppress a change in wavelength of light resulting from a change in temperature environment.

As a second conventional example, there is disclosed a compact, high-efficient, and high-output solid-state laser apparatus capable of oscillating laser light of a single wavelength or wavelengths different from each other (see e.g. patent document 2). As an example of the solid-state laser apparatus, there is disclosed an arrangement provided with a semiconductor laser light source for emitting laser light, a solid-state laser medium to be excited by the laser light from the semiconductor laser light source to oscillate oscillation laser light, an optical path changing member, disposed between the semiconductor laser light source and the solid-state laser medium, for changing the optical path of the oscillation laser light to extract the oscillation laser light in a direction different from an emitting direction of the laser light, and a wavelength converting element for converting the wavelength of the oscillation laser light. The solid-state laser apparatus having the above arrangement enables to cool a site of a solid-state laser crystal where laser light is not transmitted, secure high efficiency and high output power, and extend the wavelength region of oscillation laser light.

As a third conventional example, a solid-state laser apparatus having the following arrangement is disclosed (see e.g. patent document 3). The solid-state laser apparatus is constructed in such a manner that a solid-state laser crystal and a non-linear optical crystal constitute a laser resonator by contacting an optically transparent substrate with an excitation-light incident end surface of the solid-state laser crystal on which excitation light emitted from an excitation light source is condensed via a condensing optical system, and contacting the non-linear optical crystal with a laser-light exit end surface of the solid-state laser crystal to emit laser light by resonating the laser resonator. In this arrangement, it is possible to efficiently dissipate heat generated at an excitation-light incident portion of the laser crystal from the transparent substrate and the non-linear optical crystal in contact with both end surfaces of the laser crystal in the excitation direction, thereby stabilizing the laser output. There is also described an effect of the solid-state laser apparatus that the allowable angle range of the non-linear optical crystal can be increased five times, and light loss in the laser resonator can be reduced to 1/25 or less by setting the length of the non-linear optical crystal in the optical axis direction to one-fifth or less of the effective crystal length, thereby reducing the external influence to 1/100 or less.

As a fourth conventional example, there is disclosed a solid-state laser apparatus provided with a thin layer of an active laser material having a non-linear characteristic, a pump laser for emitting a beam of a wavelength capable of pumping the thin layer of the active laser material in a direction perpendicular to a plane of the thin layer, and two mirrors whose reflection coefficients are maximized at the laser wavelength of the active laser material. It is recited that setting the thin layer of the non-linear active laser material having the non-linear characteristic to 1 mm or less enables to mass-produce the solid-state laser apparatus (see e.g. patent document 4).

As a fifth conventional example, there is proposed a display apparatus incorporated with a laser as a light source (see e.g. patent document 5). Since the apparatus is incorporated with a laser as a light source, as compared with an apparatus incorporated with a lamp, various merits such as saving the electric power, miniaturization, and a battery-driven operation are obtained. Use of the laser is also advantageous in increasing the color reproduction range.

FIG. 34 shows an arrangement of the conventional display apparatus 401. A battery 409 supplies an electric power to a driving circuit and a light source in the display apparatus 401. Laser light outputted from a red light source 402, a blue light source 403, and a green light source 404 is guided to a galvanometric mirror 406, using dichroic mirrors 405a, 405b, and 405c. The galvanometric mirror 406 is operable to change the incident angle thereon at a high speed, and irradiate the incident laser light into a plane of a liquid crystal panel 407 with a uniform light amount. The laser light transmitted through the transparent liquid crystal panel 407 is outputted as an image through an exit lens 408.

A semiconductor laser is used as the red light source 402 (oscillation wavelength: near 640 nm), and the blue light source 403 (oscillation wavelength: near 440 nm). Since the semiconductor laser has a power-to-light conversion efficiency of several times as large as that of a lamp, use of the semiconductor laser is advantageous in realizing remarkable power consumption reduction in the apparatus. A wavelength-conversion SHG (Second Harmonic Generation) laser is used as the green light source 404. An SHG laser is used as the green light source, because a high-fidelity semiconductor laser capable of emitting green light is not currently available.

The above display apparatus is incorporated with a light source whose oscillation wavelength spectrum is limited, such as a semiconductor laser or an SHG laser. Accordingly, as compared with an arrangement incorporated with a lamp, the above arrangement enables to facilitate designing of optical components, and miniaturize an optical system, which is advantageous in miniaturizing the display apparatus.

As a sixth conventional example, there is disclosed an arrangement, wherein plural laser diodes (hereinafter, called as LDs) are used as an excitation light source, excitation light from the laser diodes is condensed by an optical system such as an optical fiber for drawing into a solid-state laser rod to excite excitation regions in the solid-state laser rod (see e.g. patent document 6). This arrangement enables to eliminate a change in optical characteristic resulting from a large thermal influence between the excitation regions, secure improvement of excitation efficiency by excitation light, and obtain, from a single solid-state laser rod, output light whose aberration is reduced by several times, as compared with the conventional art.

As a seventh conventional example, similarly to the above, there is disclosed an optical arrangement that plural semiconductor lasers are used as light sources for emitting excitation light, and the excitation light is guided to a solid-state laser medium by unifying the semiconductor lasers by an optical system such as an optical fiber; and a driving control circuit for operating the semiconductor lasers simultaneously or time-sharingly at a predetermined time interval (see e.g. patent document 7). In this arrangement, solid-state laser light can be utilized at an intended light output at a predetermined time interval.

As an eighth conventional example, there is disclosed an LD excited solid-state laser apparatus, wherein an optical system is fabricated by using a linear array of LDs or a two dimensionally stacked linear array of LDs as an excitation light source to condense excitation light on a very small spot so as to improve the oscillation efficiency of the solid-state laser apparatus, reduce the pulse width at the time of performing Q-switch pulse oscillation, and miniaturize the laser apparatus (see e.g. patent document 8). In the solid-state laser apparatus, there is also disclosed an arrangement that the cyclic frequency of the solid-state laser apparatus is increased by (n) times by operating LD drivers in parallel, thereby substantially performing a high-output operation.

In the first conventional example, laser light of 808 nm wavelength is emitted from the semiconductor laser light source to excite the solid-state laser medium using the laser light, light of 1064 nm wavelength is emitted from the solid-state laser medium for conversion into second harmonic by the non-linear optical element to extract G light of 532 nm wavelength from the optical resonator, whereby the extracted G light is used as a laser pointer. In the conventional example, the semiconductor laser light source, and the optical resonator are respectively and adhesively mounted on the heat sink and the base member made of a heat conductive metal to improve heat dissipation and suppress a change in usage environment temperature, thereby stabilizing output laser light. The first conventional example is directed to using light as a laser pointer, and the output of light is 1 mW or less. Accordingly, it is difficult to realize a high output solid-state laser apparatus based on the above arrangement.

In the second conventional example, it is possible to obtain an output as high as about 10 W for the purpose of application to a projector or a like apparatus. However, since the dimensions of a wavelength converting element having a polarization inversion structure is 2 mm by 2 mm in cross section and 10 mm in length, it is difficult to miniaturize the apparatus. Further, in the second conventional example, there is no recitation or suggestion about optimizing the thickness of a wavelength converting element.

The third conventional example is directed to an arrangement that heat is dissipated by contacting the optically transparent substrate with the laser-light incident end surface of the solid-state laser crystal. Examples of the material of an optically transparent and heat dissipative substrate are expensive materials such as sapphire and diamond. Accordingly, it is difficult not only to reduce the cost but also to improve heat dissipation.

The fourth conventional example recites that the thickness of the film layer having a laser function and capable of generating harmonic is less than 1 mm, or is set to about 100 μm. However, the conventional example is directed to realize a miniaturized light source for converting infrared light into visible light. Accordingly, in the above arrangement, it is difficult to realize a high-output power, as required in a projection display apparatus.

In the fifth conventional example, temperature control of a laser is not considered, and a wavelength change and an output change of a semiconductor laser resulting from a temperature change may occur. The wavelength change and the output change of the semiconductor laser may not only change brightness of an image to be projected but also make it difficult to control the color balance.

A wavelength conversion (SHG) light source is used as a green light source, because a reliable semiconductor laser as a green light source is not currently available. In the case where a wavelength conversion light source is used, more care on temperature control is required, as compared with a semiconductor laser, because a large temperature change may result in a large change in phase matching wavelength of a crystal to be used in wavelength conversion, and output of green light may be impossible.

In order to solve the above problem, control using a Peltier element may be proposed as temperature control means. However, in the case where a Peltier element is used, a large amount of heat may be generated from the Peltier element, which may increase the cost and electric power consumption.

In addition to the above, in the fifth conventional example, consideration on temperature control of a wavelength converting element as a component of an SHG laser is insufficient, and a long time is required until an intended green light output is obtained in driving and starting up the SHG laser from a temperature equal to or lower than a phase matching temperature. As a result, an intended increase in green light output is not obtained, and a long time may be required until an image having an intended color balance is outputted.

In the sixth conventional example, in the case where the output of fundamental light reaches in the order of watts, the excitation regions in the solid-state laser rod are subjected to a large thermal influence to each other, which obstructs a stable and a high-output operation.

In the seventh conventional example, there is no disclosure about a manner as to how the semiconductor laser as an excitation light source is simultaneously or time-sharingly driven and controlled by the driving control circuit for a stable and high-output operation.

Similarly, in the eighth conventional example, there is no disclosure about a parallel operation as to how the linear array of LDs as an excitation light source is operated by the LD drivers for a stable and high output power operation.

Specifically, in the case where a solid-state laser apparatus having a high output in the order of watts is used as a light source for a display apparatus such as a laser display apparatus, it may be difficult or impossible to realize an arrangement of a solid-state laser apparatus capable of performing a stable and high-output operation. Further, in the case where the high-output solid-state laser apparatus is used in a display apparatus, it may be difficult or impossible to realize an arrangement of a solid-state laser apparatus capable of effectively reducing speckle noise.

Patent document 1: Japanese Unexamined Patent Publication No. 2004-281932
Patent document 2: Japanese Unexamined Patent Publication No. 2005-354007
Patent document 3: Japanese Unexamined Patent Publication No. 2000-124533
Patent document 4: Japanese Unexamined Patent Publication No. Hei 3-185772
Patent document 5: Japanese Unexamined Patent Publication No. Hei 6-208089
Patent document 6: Japanese Unexamined Patent Publication No. Hei 5-145148
Patent document 7: Japanese Unexamined Patent Publication No. Hei 4-247674
Patent document 8: Japanese Unexamined Patent Publication No. Hei 9-199774

### DISCLOSURE OF THE INVENTION

It is an object of the invention to provide a temperature-stable and high-output solid-state laser apparatus capable of inputting large-output fundamental laser light to a wavelength converting element disposed in an optical resonator including of a solid-state laser medium and a mirror, with improved conversion efficiency and an increased allowable temperature range.

A solid-state laser apparatus according to an aspect of the invention includes: a semiconductor laser light source for emitting laser light; an optical resonator including a solid-state laser medium to be excited by incidence of the laser light to oscillate fundamental laser light, and a mirror; and a quasi phase matching wavelength converting element, disposed in the optical resonator, for converting a wavelength of the fundamental laser light, wherein the quasi phase matching wavelength converting element is formed with a polarization inversion region having a predetermined cycle, and the length of the polarization inversion region in an optical axis direction is 1.0 mm or less.

The above arrangement enables to realize a temperature-stable and high-output solid-state laser apparatus capable of inputting large-output fundamental laser light to the wavelength converting element disposed in the optical resonator including the solid-state laser medium and the mirror, with improved conversion efficiency and an increased allowable temperature range.

### BRIEF DESCRIPTION OF THE DRAWINGS

FIG. 1 is a schematic diagram for describing an arrangement of a solid-state laser apparatus in accordance with the first embodiment of the invention.

FIG. 2 is a diagram showing a result, wherein the element length of an SHG element, and an output of green light as harmonic laser light are obtained by using an output of laser light as pump light as a parameter in the first embodiment.

FIG. 3 is a diagram showing a result, wherein a change in output of G light resulting from a temperature change is obtained by using the element length of the SHG element as a parameter in the first embodiment.

FIG. 4 is a diagram showing a result, wherein an output of fundamental laser light with respect to an output of laser light as pump light is obtained by using the element length of the SHG element as a parameter, in the case where the SHG element is provided in an optical resonator in the first embodiment.

FIG. 5 is a diagram showing a result of a relation between a saturated pump output and the element length in the first embodiment.

FIG. 6 is a diagram showing a result of a relation between the element length of the SHG element and an output of green light, based on the result shown in FIG. 5.

FIG. 7 is a diagram showing a relation between a wavelength conversion characteristic and a spectrum of solid-state laser light in vertical mode, and a wavelength characteristic of G light, in the case where the element length of the SHG element is 2 mm.

FIG. 8 is a diagram showing a relation between a wavelength conversion characteristic and a spectrum of solid-state laser light in vertical mode, and a wavelength characteristic of G light, in the case where the element length of the SHG element is 0.5 mm.

FIG. 9 is a schematic diagram showing an arrangement of a solid-state laser apparatus in accordance with the second embodiment of the invention.

FIG. 10 is a schematic diagram showing an arrangement of a projection display apparatus in accordance with the third embodiment of the invention.

FIG. 11 is a schematic diagram showing an arrangement of a projection display apparatus in accordance with the fourth embodiment of the invention.

FIG. 12 is a schematic diagram showing an arrangement of a projection display apparatus in accordance with the fifth embodiment of the invention.

FIG. 13 is a schematic diagram showing an arrangement of an SHG laser to be used as a green light source in FIG. 12.

FIG. 14 is a diagram for describing a wavelength change with respect to a temperature of a pumping semiconductor laser.

FIG. 15 is a diagram showing an oscillation spectrum of the pumping semiconductor laser.

FIG. 16 is a diagram showing a temperature characteristic versus conversion efficiency of a wavelength converting element.

FIG. 17 is a flowchart for describing a control method to be performed in starting up the projection display apparatus shown in FIG. 12.

FIG. 18 is a diagram showing a transmittance versus wavelength of a wavelength converting element to be used in a projection display apparatus in accordance with the sixth embodiment of the invention.

FIG. 19 is a diagram showing a light source and peripheral parts thereof in a projection display apparatus in accordance with the seventh embodiment of the invention.

FIG. 20 is a diagram for describing a structure of a wavelength converting element to be used in a projection display apparatus in accordance with the eighth embodiment of the invention.

FIG. 21 is a diagram showing a temperature characteristic versus conversion efficiency of the wavelength converting element shown in FIG. 20.

FIG. 22 is a top plan view of a solid-state laser light source in the ninth embodiment of the invention.

FIG. 23 is a side view of the solid-state laser light source taken along the line 23A-23A in FIG. 22.

FIG. 24 is an enlarged view of a wavelength converting element shown in FIG. 22.

FIG. 25 is a schematic diagram showing an arrangement of a semiconductor element constituted of plural semiconductor laser elements usable in a projection display apparatus shown in FIG. 22.

FIG. 26 is a time chart showing an operation to be performed by the solid-state laser light source shown in FIG. 22.

FIG. 27 is a diagram showing a state that the solid-state laser light source shown in FIG. 22 emits multi-beams constituted of two beams.

FIG. 28 is a schematic construction diagram showing a solid-state laser light source in accordance with the tenth embodiment of the invention.

FIG. 29 is a schematic construction diagram showing a solid-state laser light source in accordance with the eleventh embodiment of the invention.

FIG. 30 is a schematic construction diagram showing a solid-state laser light source in accordance with the twelfth embodiment of the invention.

FIG. 31 is a schematic construction diagram of an image display apparatus in accordance with the thirteenth embodiment of the invention.

FIG. 32 is a schematic construction diagram of an image display apparatus in accordance with the fourteenth embodiment of the invention.

FIG. 33 is a schematic construction diagram of an image display apparatus in accordance with the fifteenth embodiment of the invention.

FIG. 34 is a schematic diagram showing an arrangement of a conventional display apparatus.

### BEST MODE FOR CARRYING OUT THE INVENTION

In the following, embodiments of the invention are described referring to the drawings. Like elements have like reference numerals, and repeated description may be omitted. The drawings are enlargedly illustrated for easy understanding, and dimensions or the like of the elements may be incorrectly displayed.

### First Embodiment

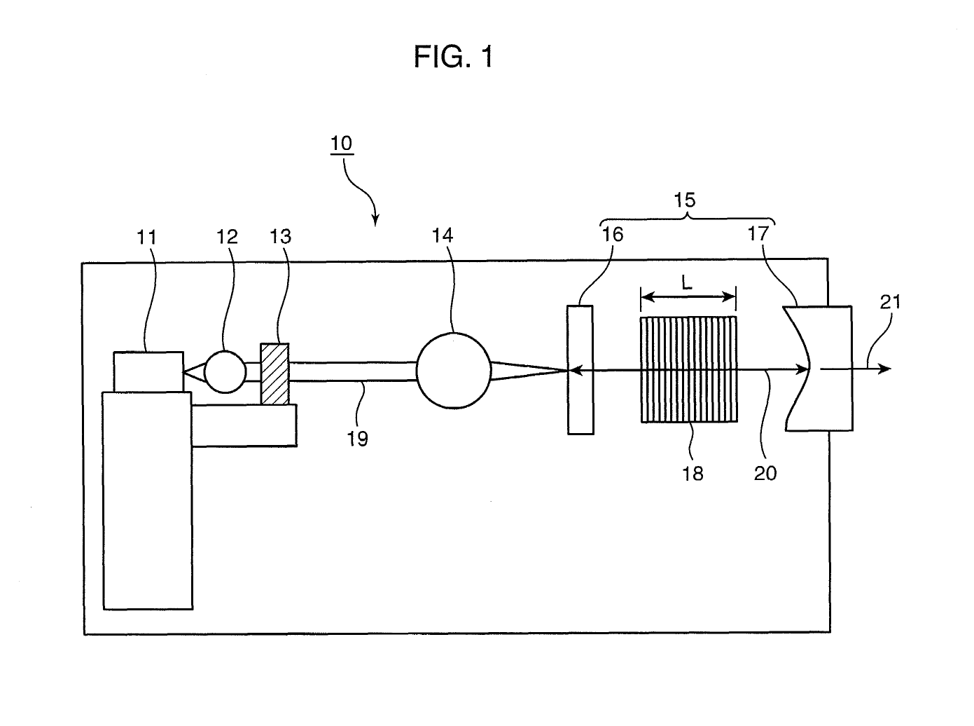

FIG. 1 is a schematic diagram for describing an arrangement of a solid-state laser apparatus 10 in accordance with the first embodiment of the invention. The solid-state laser apparatus 10 includes a semiconductor laser light source 11 for emitting laser light 19; an optical resonator 15 constituted of a solid-state laser medium 16 to be excited by incidence of the laser light 19 to oscillate fundamental laser light 20, and a concave surface mirror 17; and an SHG element (quasi phase matching wavelength converting element) 18 disposed in the optical resonator 15 and for converting the wavelength of the fundamental laser light 20.

The SHG element 18 is formed with a polarization inversion region having predetermined cycle. The length of the polarization inversion region in the optical axis direction i.e. the length (element length) L of the SHG element 18 in the optical axis direction is preferably 1.0 mm or less, more preferably not less than 0.3 mm and not more than 0.6 mm, and furthermore preferably not less than 0.4 mm and not more than 0.5 mm for the following reason.

As shown in FIG. 1, the solid-state laser apparatus 10 in this embodiment is basically the same as the conventional apparatus in construction, but is operable to increase the output of harmonic laser light while miniaturizing the overall size of the apparatus, with an increase in the allowable temperature range, by setting the element length L of the SHG element 18 in the aforementioned predetermined range.

In this embodiment, described is an arrangement of the solid-state laser apparatus 10, wherein pump light (excitation light) of 808 nm oscillation wavelength is incident as the laser light 19 to generate the fundamental laser light 20 of 1064 nm wavelength, and the fundamental laser light 20 is converted into the harmonic laser light 21 of 532 nm wavelength for output. In the following, the arrangement is described in detail referring to FIG. 1.

The solid-state laser apparatus 10 in this embodiment includes the semiconductor laser light source 11 for oscillating laser light of a wavelength near 808 nm oscillation wavelength, a rod lens 12, a VBG (Volume Bragg Grating) 13, a ball lens 14, a solid-state laser medium 16, the SHG element 18, and the mirror (hereinafter, called as a concave surface mirror) 17 having a concave surface.

The laser light 19 of the wavelength near 808 nm emitted from the semiconductor laser light source 11 has a vertical direction component thereof collimated by the rod lens 12, and then incident into the VBG 13. A part of the laser light 19 incident into the VBG 13 is reflected and fed back to the semiconductor laser light source 11. As a result of this operation, the oscillation wavelength of the semiconductor laser light source 11 is locked into a wavelength (808 nm) selected by the VBG 13 serving as an oscillation wavelength fixing portion for fixing the oscillation wavelength of laser light. In this way, use of the VBG 13 is advantageous in substantially constantly keeping the oscillation wavelength of the semiconductor laser light source 11 without depending on a temperature change, thereby enabling to eliminate high-precision temperature control of the semiconductor laser light source 11.

In this embodiment, the VBG 13 is used to lock the oscillation wavelength of the semiconductor laser light source 11. Alternatively, a band-pass filter constituted of a dielectric multilayer coating may be used. Further alternatively, the semiconductor laser light source 11 itself may be constructed to be a DFB (Distributed FeedBack) laser or a DBR (Distributed Bragg Reflector) laser having a wavelength locking function.

The laser light 19 whose wavelength is locked by the VBG 13 is condensed on the solid-state laser medium 16 by the ball lens 14. The laser light 19 turns into pump light to excite the solid-state laser medium 16, and the fundamental laser light 20 of 1064 nm wavelength is generated. The fundamental laser light 20 is resonated in the optical resonator 15 constituted of the solid-state laser medium 16 and the concave surface mirror 17. Then, a part of the fundamental laser light 20 is subjected to wavelength conversion by the SHG element 18 disposed in the optical resonator 15, and is outputted to the exterior as the harmonic laser light 21 of 532 nm wavelength.

An end surface of each of the solid-state laser medium 16, the SHG element 18, and the concave surface minor 17 is formed with a dielectric multilayer coating so that the laser light 19 as pump light is incident into the optical resonator 15, the fundamental laser light 20 is trapped in the optical resonator 15, and the harmonic laser light 21 is emitted from the concave surface minor 17.

In this embodiment, 3% Nd-doped YVO₄ crystal is used as the solid-state laser medium 16. A quasi phase matching element constructed by cyclically forming a polarization inversion region on an Mg-doped LiNbO₃ substrate is used as the SHG element 18. The Mg-doped LiNbO₃ substrate has a large non-linear constant, which is advantageous in reducing the thickness of the SHG element. Other examples of the material for the SHG element are KTP, LBO, and LiTaO₃.

KTP has an advantage that the usable temperature range is wide, but has a disadvantage that a phenomenon called “gray tracking” may occur resulting from G light output of several hundred watts or more, which may color the crystal, and increase the transmittance loss. LBO has no particular problem relating to high-output power, but it is required to control the temperature of the crystal in the vicinity of 148° C. As a result, electric power consumption is increased, and wavelength conversion efficiency is lowered. LiTaO₃ has an excellent high-output characteristic, but has low wavelength conversion efficiency, as compared with LiNbO₃. Accordingly, electricity-light conversion efficiency of a light source may be lowered, as compared with the case of using LiNbO₃. In view of the above reasons, Mg-doped LiNbO₃ is an optimal material.

Next, there is described a result of assessing various characteristics of the solid-state laser apparatus 10 in this embodiment, based on the element length of the SHG element 18.

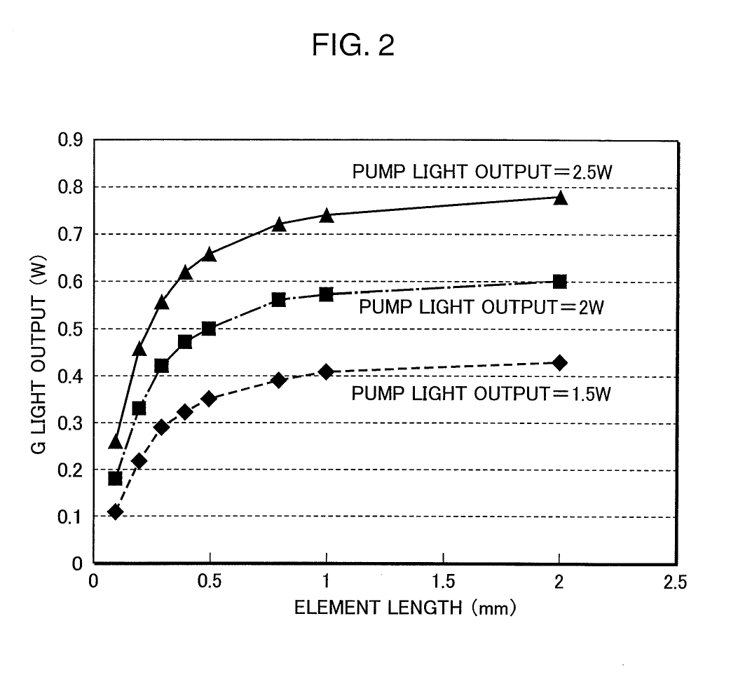

FIG. 2 is a diagram showing a result, wherein the element length of the SHG element 18, and an output of G light (532 nm) as the harmonic laser light 21 are obtained by using an output of the laser light 19 as pump light as a parameter. As shown in FIG. 2, as the element length of the SHG element 18 is increased, the output of G light is increased. However, if the element length is in excess of 1 mm, the output of G light almost saturates. Further, if the element length is increased, a partial temperature variation may occur resulting from absorption of G light by the SHG element 18, and the effective polarization inversion cycle is likely to vary.

In view of the result shown in FIG. 2, preferably, the element length of the SHG element 18 in the optical axis direction is 1.0 mm or less. Since this arrangement avoids variation in polarization inversion cycle, the temperature characteristic can be improved, and the usable temperature range can be increased.

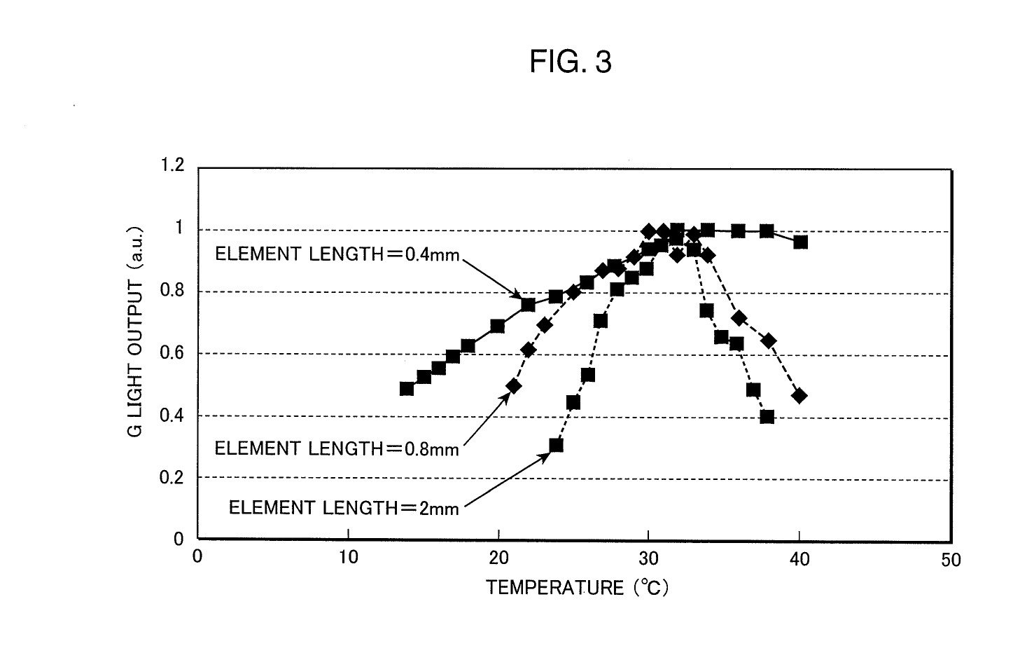

FIG. 3 is a diagram showing a result, wherein a change in output of G light resulting from a temperature change is obtained by using the element length of the SHG element 18 as a parameter. As shown in FIG. 3, as the element length of the SHG element 18 is decreased, the allowable temperature range can be increased. For instance, in the where the element length is 2 mm, the allowable temperature range is 12° C.; in the where the element length is 0.8 mm, the allowable temperature range is 18° C.; and in the where the element length is 0.4 mm, the allowable temperature range is 36° C. In other words, the allowable temperature range is basically inversely proportional to the element length of the SHG element 18. Accordingly, the more the element length is decreased, the more the allowable temperature range can be increased.

In this embodiment, it is preferable to securely obtain 20° C. or more as an allowable temperature range, considering the usage environment of the apparatus. Accordingly, it is desirable to set the optimal element length to 0.6 mm or less in the aspect of allowable temperature range. In the case where the element length is 2 mm, normally, the allowable temperature range is from 7° C. to 8° C. However, in FIG. 3, the substantially allowable temperature range is about 12° C. due to a variation in polarization inversion cycle resulting from a heat distribution.

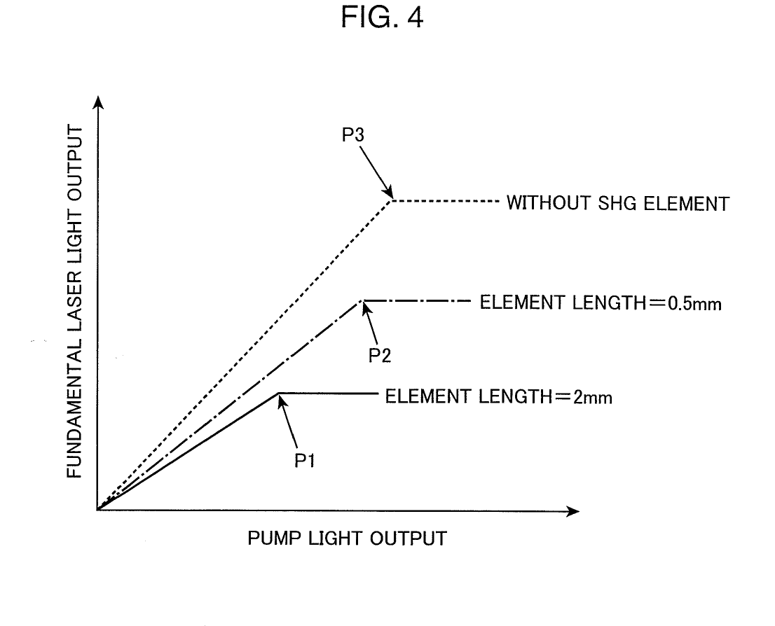

FIG. 4 is a diagram showing a result, wherein the output of the fundamental laser light 20 with respect to the output of the laser light 19 as pump light is obtained by using the element length of the SHG element 18 as a parameter, in the case where the SHG element 18 is disposed in the optical resonator 15. In the case where the SHG element 18 is disposed in the optical resonator 15, the SHG element 18 may increase light loss in the optical resonator 15. In view of this, as shown in FIG. 4, the element length of the SHG element 18 is increased, the gradient of a straight line representing an output of the fundamental laser light 20 with respect to an output of pump light is decreased. In other words, in the case where the same pump light is inputted to the solid-state laser medium 16, as the element length is increased, the output of the fundamental laser light is decreased.

As the element length of the SHG element 18 is increased, the light to be outputted to the exterior is decreased, and converted into a heat. As a result, heat generation in the optical resonator 15 is increased. Thereby, heat saturation of the solid-state laser medium 16 occurs. Specifically, in the case where the element length is 2 mm, the output of the fundamental laser light 20 is saturated when the output of pump light reaches P1 in FIG. 4. Further, in the case where the element length is 0.5 mm, the output of the fundamental laser light 20 is saturated at the point P2. Furthermore, in the case where the SHG element 18 is not provided, the output of the fundamental laser light 20 is saturated at the point P3. Thus, as the element length of the SHG element 18 is increased, the maximal value of the output of the fundamental laser light 20 is decreased.

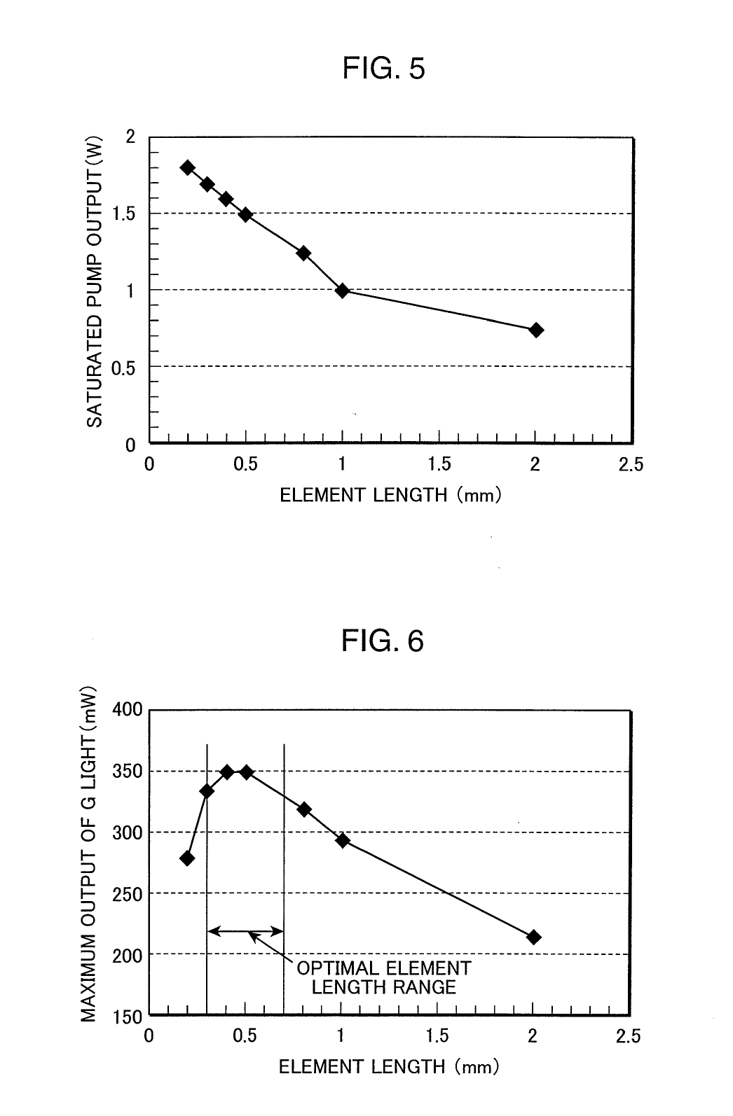

FIG. 5 is a diagram showing a result of a relation between the output (hereinafter, called as the saturated pump output) of the laser light 19 as pump light, and the element length in the case where the output of the fundamental laser light 20 is saturated. As shown in FIG. 5, as the element length of the SHG element 18 is increased, the saturated pump output is decreased.

FIG. 6 is a diagram showing a result of a relation between the element length of the SHG element 18 and the output of G light, based on the result shown in FIG. 5. It has been found that it is preferable to set the range of the optimal element length, in place of simply increasing the element length of the SHG element 18, as implemented in the conventional art, to increase the output of G light. The range is from 0.3 mm to 0.7 mm, as is obvious from FIG. 6. However, it is desirable to set the optimal element length to 0.6 mm or less in the aspect of the allowable temperature range as described above. Accordingly, it has been found that it is further desirable to set the element length range from 0.3 mm to 0.6 mm, and furthermore desirable to set the element length range from 0.4 mm to 0.5 mm.

As described above, setting the element length of the SHG element 18 in the aforementioned range enables to avoid a variation in polarization inversion cycle of the SHG element 18, and increase the allowable temperature range. As a result, generation of waste heat can be suppressed, and high-precision heat control can be eliminated. This is advantageous in obtaining the solid-state laser apparatus 10 capable of outputting high-output G light at a low cost.

In the case where the element length of the SHG element 18 is long, the conversion efficiency is likely to be lowered, without maintaining uniformity of the polarization inversion region in the element. In this embodiment, however, a polarization inversion region having enhanced uniformity can be easily formed by setting the length of the SHG element 18 in the range from 0.3 to 0.6 mm. Use of the SHG element 18 having the above range is advantageous in producing the SHG element 18 having high conversion efficiency, enhanced quality of an output light beam, less influence from a variation in polarization inversion cycle, and an increased yield at the time of production.

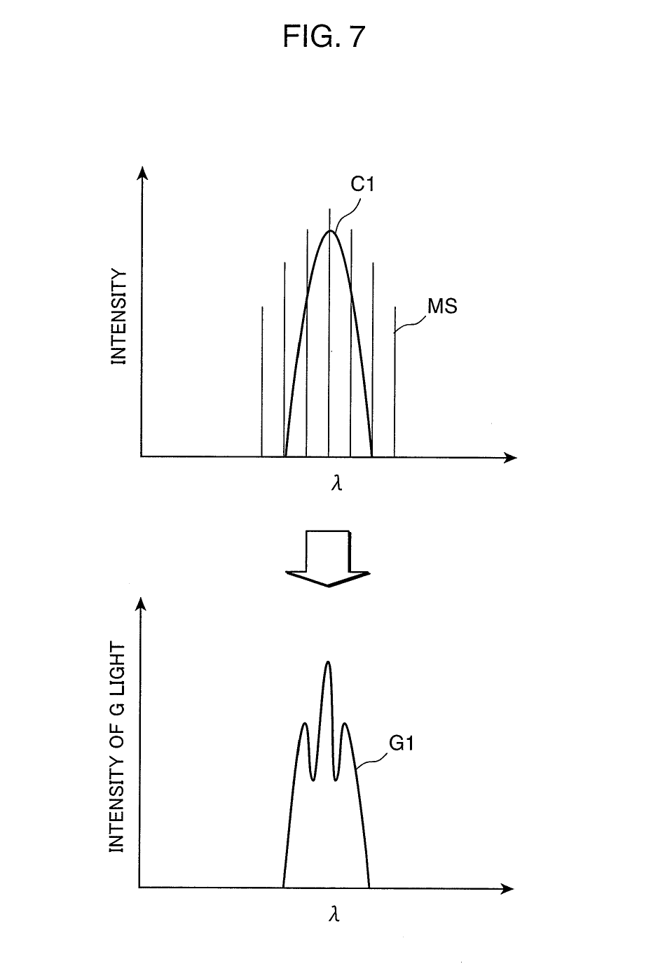

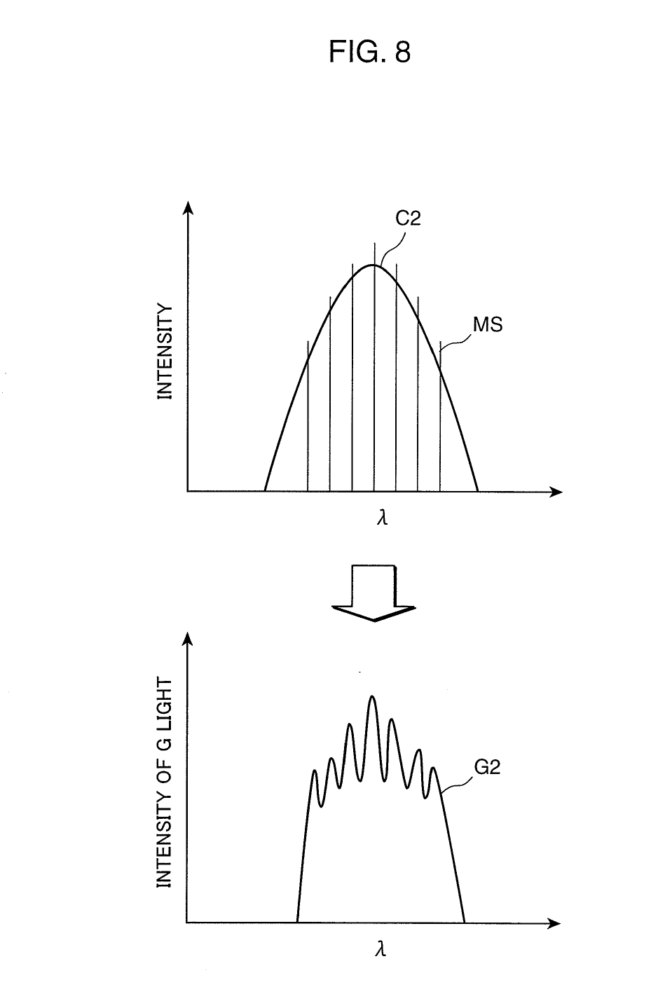

FIG. 7 is a diagram showing a relation between a wavelength conversion characteristic and a spectrum of solid-state laser light in vertical mode, and a wavelength characteristic of G light, in the case where the length of the SHG element 18 is 2 mm. FIG. 8 is a diagram showing a relation between a wavelength conversion characteristic of the SHG element 18, and a spectrum of solid-state laser light in vertical mode, and a wavelength characteristic of G light, in the case where the length of the SHG element 18 is 0.5 mm.

As shown in FIGS. 7 and 8, as the element length of the SHG element 18 is decreased, the wavelength conversion characteristic is changed from C1 to C2, and the allowable range of the wavelength conversion characteristic is increased. In the case where the spectrum MS of solid-state laser light (the fundamental laser light 20 to be oscillated from the solid-state laser medium 16) in vertical mode lies within the allowable wavelength range, the wavelength of the solid-state laser light is converted into a wavelength of ½ of the wavelength in vertical mode. Thus, the allowable range of the wavelength conversion characteristic is increased by reducing the element length of the SHG element 18. Accordingly, the number of spectra of solid-state laser light in vertical mode within the allowable range is increased. As a result, the wavelength characteristic of G light is changed from G1 to G2, and the wavelength width of G light output is increased. An increase in the wavelength bandwidth indicates reduction of speckle noise. Thus, setting the length of the SHG element in the range from 0.3 to 0.6 mm enables to reduce a speckle noise, and obtain an intended image.

In the solid-state laser apparatus 10 in this embodiment, an optical resonator is constituted of the concave surface mirror 17. The invention is not limited to the above. For instance, a microchip structure may be employed by applying a coat for reflecting the fundamental laser light 20 on a surface of the SHG element 18 where the harmonic laser light 21 exits to form a mirror, and disposing the SHG element 18 in proximity to the solid-state laser medium 16.

### Second Embodiment

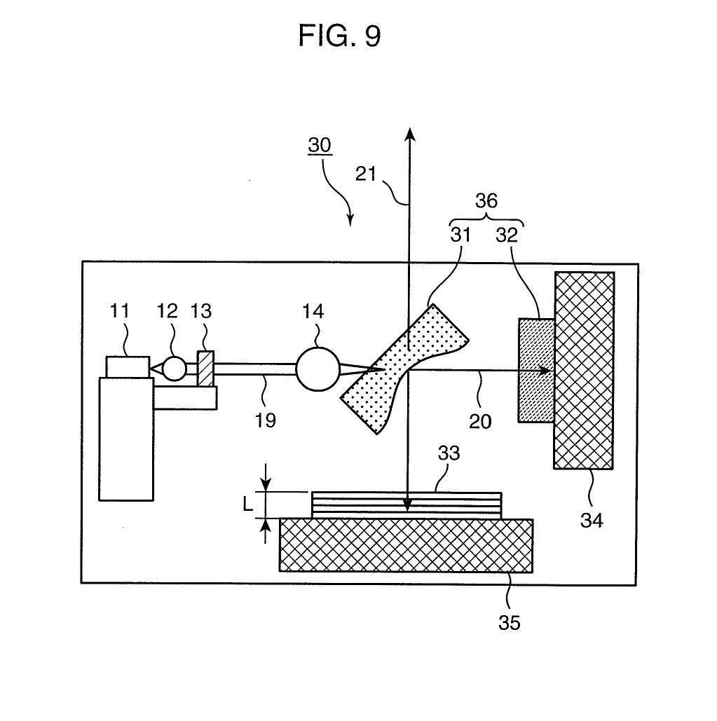

FIG. 9 is a schematic diagram showing an arrangement of a solid-state laser apparatus 30 in accordance with the second embodiment of the invention. The solid-state laser apparatus 30 includes a semiconductor laser light source 11 for emitting laser light 19; an optical resonator 36 constituted of a solid-state laser medium 32 to be excited by incidence of the laser light 19 to oscillate fundamental laser light 20, and a mirror (hereinafter, called as a concave surface mirror) 31 having a concave surface; and an SHG element 33 disposed in the optical resonator 36 and for converting the wavelength of the fundamental laser light 20.

As shown in FIG. 9, the entire arrangement of the solid-state laser apparatus 30 in the second embodiment is the same as the entire arrangement of the solid-state laser apparatus 10 shown in FIG. 1. Similarly to the first embodiment, in this embodiment, the SHG element 33 is formed with a polarization inversion region having a predetermined cycle. The length of the polarization inversion region in the optical axis direction i.e. the length (element length) L of the SHG element 33 in the optical axis direction is preferably 1.0 mm or less, more preferably not less than 0.3 mm and not more than 0.6 mm, and furthermore preferably not less than 0.4 mm and not more than 0.5 mm.

The feature of the second embodiment resides in that the arrangement of the optical resonator 36 is different from that of the optical resonator 15 shown in FIG. 1. Specifically, the concave surface mirror 31 is arranged with an inclination of 45 degrees with respect to a light incident surface of the solid-state laser medium 32 and a light incident surface of the SHG element 33, respectively. The above arrangement allows for incidence of the laser light 19 as pump light into the solid-state laser medium 32 via the concave surface mirror 31, incidence of the fundamental laser light 20 into the SHG element 33 via the concave surface mirror 31, and incidence of harmonic laser light 21 converted by the SHG element 33 via the concave surface mirror 31.

The solid-state laser medium 32 and the SHG element 33 are respectively attached to heat sinks 34 and 35 by a high heat releasable adhesive agent to efficiently dissipate heat generated in the solid-state laser medium 32 and the SHG element 33. For instance, a metal having high heat conductivity such as copper may be used as a material for the heat sink 34, 35. In view of this, the solid-state laser medium 32 and the SHG element 33 may be attached to the heat sinks 34 and 35 by soldering or like means.

Next, an arrangement of emitting the harmonic laser light 21 of 532 nm wavelength is described in this embodiment. In the solid-state laser apparatus 30, an optical resonator is constituted of the solid-state laser medium 32, the concave surface mirror 31, and the SHG element 33; and an end surface of each of the solid-state laser medium 32, the SHG element 33, and the concave surface mirror 31 is formed with a dielectric multilayer coating serving as an anti reflective coating or a high reflective coating so that the laser light 19 as pump light is incident into the optical resonator through the concave surface mirror 31, the fundamental laser light 20 is trapped in the optical resonator 36, and the harmonic laser light 21 is emitted from the concave surface mirror 31.

More specifically, an anti reflective coating capable of transmitting light of 532 nm wavelength, and an anti reflective coating capable of transmitting light of 808 nm wavelength are formed on a surface of the concave surface mirror 31 where the laser light 19 is incident: and an anti reflective coating capable of transmitting light of 532 nm wavelength, an anti reflective coating capable of transmitting light of 808 nm wavelength, and a high reflective coating capable of reflecting light of 1064 nm wavelength are formed on a surface of the concave surface mirror 31 where the fundamental laser light 20 is reflected.

An anti reflective coating capable of transmitting light of 808 nm wavelength, and an anti reflective coating capable of transmitting light of 1064 nm wavelength are formed on a surface of the solid-state laser medium 32 where the fundamental laser light 20 is incident. A high reflective coating capable of reflecting light of 1064 nm wavelength is formed on the surface of the solid-state laser medium 32 corresponding to the heat sink 34. Alternatively, the high reflective coating may be formed on the heat sink 34.

An anti reflective coating capable of transmitting light of 532 nm wavelength, and an anti reflective coating capable of transmitting light of 1064 nm wavelength are formed on the surface of the SHG element 33 where the fundamental laser light 20 is incident. A high reflective coating capable of reflecting light of 532 nm wavelength and a high reflective coating capable of reflecting 1064 nm wavelength are formed on the surface of the SHG element 33 corresponding to the heat sink 35. Alternatively, the high reflective coating may be formed on the heat sink 35.

Forming the anti reflective coating and the high reflective coating allows for incidence of the laser light 19 as pump light into the solid-state laser medium 32 through the concave surface mirror 31; allows for reflection of the fundamental laser light 20 to be emitted from the solid-state laser medium 32 by the concave surface mirror 31 for incidence into the SHG element 33; and allows for output of the harmonic laser light 21 converted by the SHG element 33 through the concave surface mirror 31.

In the above arrangement, the element length of the SHG element 33 is as small as from 0.3 mm to 0.6 mm, and the SHG element 33 is adhesively fixed to the heat sink 35 in a small heat resistant state. Accordingly, the heat generated in the SHG element 33 can be further efficiently dissipated therefrom. Further, this arrangement enables to adhesively fix the solid-state laser medium 32 on the sufficiently large heat sink 34 in a small heat resistant state. Accordingly, heat generated in the solid-state laser medium 32 can be efficiently released therefrom in the similar manner as described above.

As described above, similarly to the first embodiment, setting the element length of the SHG element 33 in the range from 0.3 mm to 0.6 mm enables to obtain large-output G light with an optimal pump light output as described above, and avoids waste of heat by conversion of laser light into heat. This is advantageous in suppressing heat generation. Thus, the solid-state laser apparatus 30 capable of outputting large-output and stable G light, without the need of high-precision heat control.

### Third Embodiment

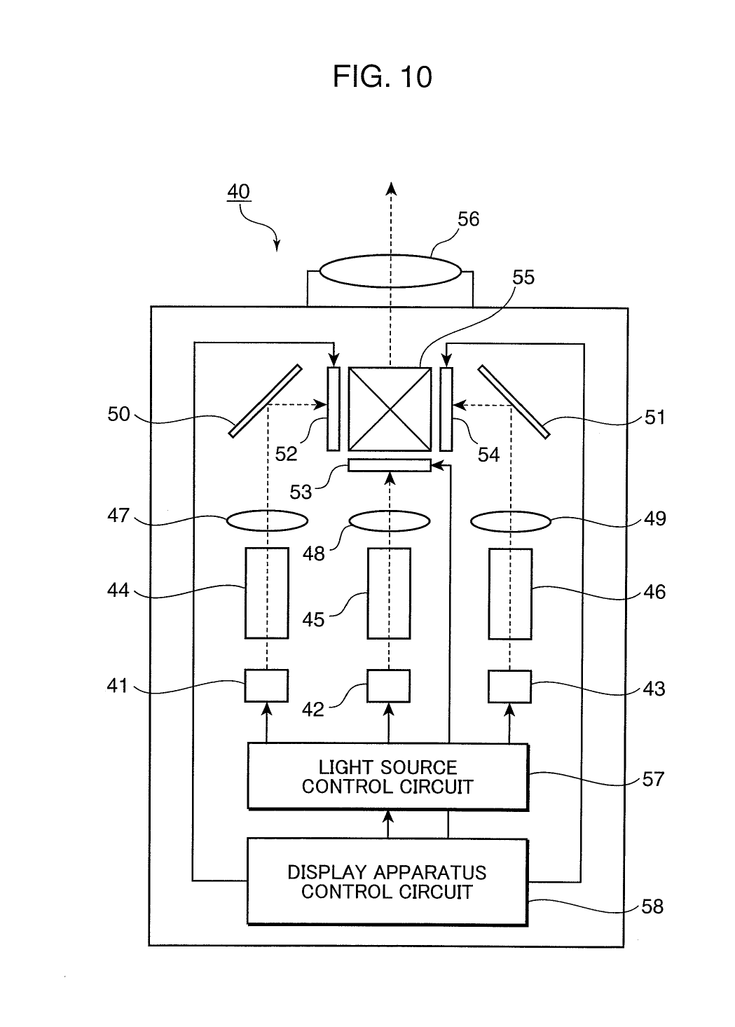

FIG. 10 is a schematic diagram showing a projection display apparatus 40 in accordance with the third embodiment of the invention. The projection display apparatus 40 includes image conversion devices 52, 53, and 54 for converting an image signal into an image, and illumination light sources 41, 42, and 43 for illuminating the image conversion devices 52, 53, and 54. The illumination light sources 41, 42, and 43 are a red light source 41, a green light source 42, and a blue light source 43. The green light source 42 out of the red light source 41, the green light source 42, and the blue light source 43 is constituted of the solid-state laser apparatus 10 recited in the first embodiment.

In the projection display apparatus 40, the image conversion devices 52, 53, and 54 each is constituted of a transparent liquid crystal display panel, as a kind of a two-dimensional space modulation device. The image conversion devices 52, 53, and 54 are arranged at such positions as to receive laser light to be emitted from the red light source 41, the green light source 42, and the blue light source 43 constituting illumination light sources, respectively. Image light transmitted through the image conversion devices 52, 53, and 54 constituting the transparent liquid crystal display panels is combined by a combination prism 55 for output through an exit lens 56. In the following, the image conversion devices 52, 53, and 54 are described as transparent liquid crystal panels 52, 53, and 54.

A more specific arrangement is described in detail referring to FIG. 10. Light amount distributions of laser light outputted from the red light source 41, the green light source 42, and the blue light source 43 are respectively made uniform, using rod integrators 44, 45, and 46. After the laser light emitted from the red light source 41, and the laser light emitted from the blue light source 43 are guided to reflection mirrors 50 and 51 through lenses 47 and 49, optical paths of the laser light are converted by the reflection mirrors 50 and 51 to be guided to the transparent liquid crystal panels 52 and 54, respectively. On the other hand, the laser light from the green light source 42 is directly guided to the transparent liquid crystal panel 53 through a lens 48. The laser light respectively transmitted through the transparent liquid crystal panels 52, 53, and 54 is combined by the combination prism 55 for output as image light through the exit lens 56.

In the projection display apparatus 40, semiconductor lasers are respectively used as the red light source (oscillation wavelength: about 640 nm), and the blue light source 43 (oscillation wavelength: about 440 nm), and the solid-state laser apparatus 10 in accordance with the first embodiment is used as the green light source 42 (oscillation wavelength: about 532 nm).

A light source control circuit 57 controls light output of the red light source 41, the green light source 42, and the blue light source 43. A display apparatus control circuit 58 drives the three transparent liquid crystal panels 52, 53, and 54 based on an image signal. Specifically, the display apparatus control circuit 58 drives the transparent liquid crystal panel 52 for, receiving laser light from the red light source 41 based on an image signal for red color; drives the transparent liquid crystal panel 53 for receiving laser light from the green light source 42 based on an image signal for green color; and drives the transparent liquid crystal panel 54 for receiving laser light from the blue light source 43 based on an image signal for blue color.

The display apparatus control circuit 58 may control the light source control circuit 57, as necessary. For instance, oscillation of laser light from the red light source 41, the green light source 42, and the blue light source 43 may be suspended to display a monochromatic image. Further alternatively, the output of laser light from the red light source 41, the green light source 42, or the blue light source 43 may be made variable. Performing the above control enables to enhance the quality of an image to be displayed, and reduce the electric power consumption.

Since an arrangement of a conventional transparent liquid crystal display apparatus e.g. a panel configuration incorporated with a polysilicon TFT drive circuit may be used in the transparent liquid crystal panels 52, 53, and 54, description on the arrangement of the transparent liquid crystal display panels 52, 53, and 54 is omitted herein.

The projection display apparatus 40 is incorporated with laser light sources having a feature that light from each of the RGB light sources is monochromatic light and has a high color purity. Accordingly, the projection display apparatus 40 is capable of displaying a clear image with an increased color reproducible range and a high color purity. The above arrangement enables to suppress electric power consumption, as compared with an arrangement of using a lamp as a light source.

### Fourth Embodiment

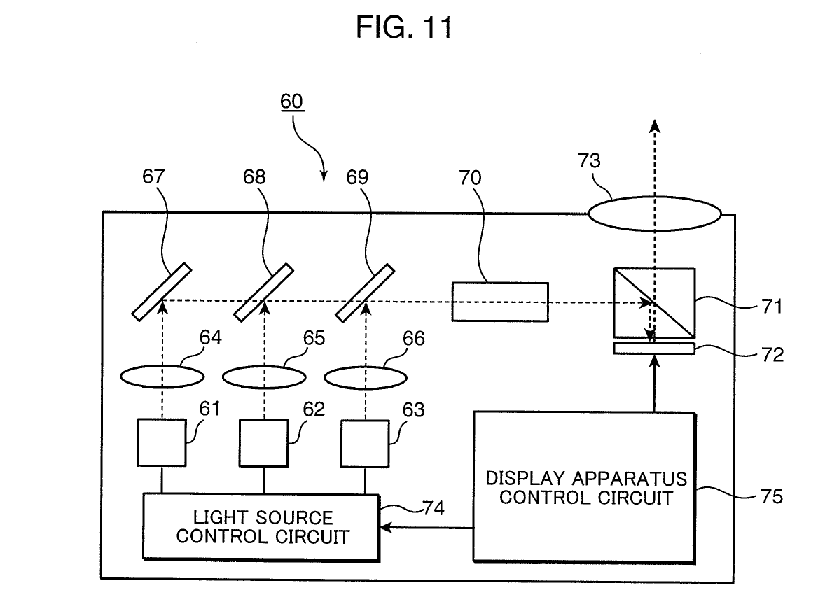

FIG. 11 is a schematic diagram showing a projection display apparatus 60 in accordance with the fourth embodiment of the invention. The feature of the projection display apparatus 60 resides in that a single image conversion device 72 is provided in the projection display apparatus 60. Similarly to the third embodiment, the projection display apparatus 60 includes illumination light sources constituted of a red light source 61, a green light source 62, and a blue light source 63. Semiconductor laser light sources are respectively used as the red light source 61 and the blue light source 63, and the solid-state laser apparatus 10 in accordance with the first embodiment is used as the green light source 62.

Laser light emitted from the light sources is incident onto dichroic mirrors 67, 68, and 69 through lenses 64, 65, and 66, respectively, for combination of the laser light of three colors, and then incident into a polarization beam splitter 71 through a uniformity optical system 70. Thereafter, the combined laser light is incident into the image conversion device 72. In the projection display apparatus 60, a reflective liquid crystal display panel as a kind of a two-dimensional space modulation device is used as the image conversion device 72. The laser light incident into the image conversion device 72 constituted of the reflective liquid crystal display panel is reflected in accordance with an image signal for output as image light through an exit lens 73.

Since the function and the operation of a light source control circuit 74 and a display apparatus control circuit 75 are the same as those of the light source control circuit 57 and the display apparatus control circuit 58 in the projection display apparatus 40, description thereof is omitted herein. Since a conventional reflective liquid crystal display panel or a like device can be used as the image conversion device 72 constituted of a reflective liquid display panel, description of the image conversion device 72 is also omitted herein. It would be easily understood that the invention is also applicable to an arrangement that a mirror device such as DMD is used as a two-dimensional space modulation device.

The projection display apparatus 60 is incorporated with laser light sources having a feature that light of each of the RGB light sources is monochromatic light, and has a high color purity. Accordingly, the projection display apparatus 60 is capable of displaying a clear image with an increased color reproducible range and a high color purity. The above arrangement enables to suppress electric power consumption, as compared with an arrangement of using a lamp as a light source.

The projection display device 40, 60 is incorporated with the solid-state laser apparatus 10 in accordance with the first embodiment. Alternatively, the solid-state laser apparatus 30 in accordance with the second embodiment or a like apparatus may be incorporated. The modification is advantageous in obtaining a projection display apparatus with less variation in e.g. image quality, without depending on a change in environment temperature.

In the foregoing description, the arrangement of outputting G light is described as the solid-state laser apparatus. For instance, substantially the same effect as described above can be obtained in a solid-state laser apparatus for outputting harmonic (harmonic laser light) of a wavelength obtained by combination of a semiconductor laser light source, a solid-state laser medium, and an SHG element, and having an arrangement capable of outputting B light, light of a wavelength between G light and B light, light of a wavelength between G light and R light, and the like.

### Fifth Embodiment

In the fifth through the eighth embodiments, described is an arrangement of a projection display apparatus constructed such that pump light to be emitted from a pumping semiconductor laser equipped with means for locking the oscillation wavelength is incident into a solid-state laser, and having an SHG laser for converting the wavelength of fundamental light (fundamental laser light) excited and oscillated by the pump light by using a quasi phase matching wavelength converting element in a resonator, wherein the projection display apparatus is internally provided with the semiconductor laser, the SHG laser, fans, and a laser temperature detector to control the temperatures of the semiconductor laser and the SHG laser to a proper setting temperature by the fans.

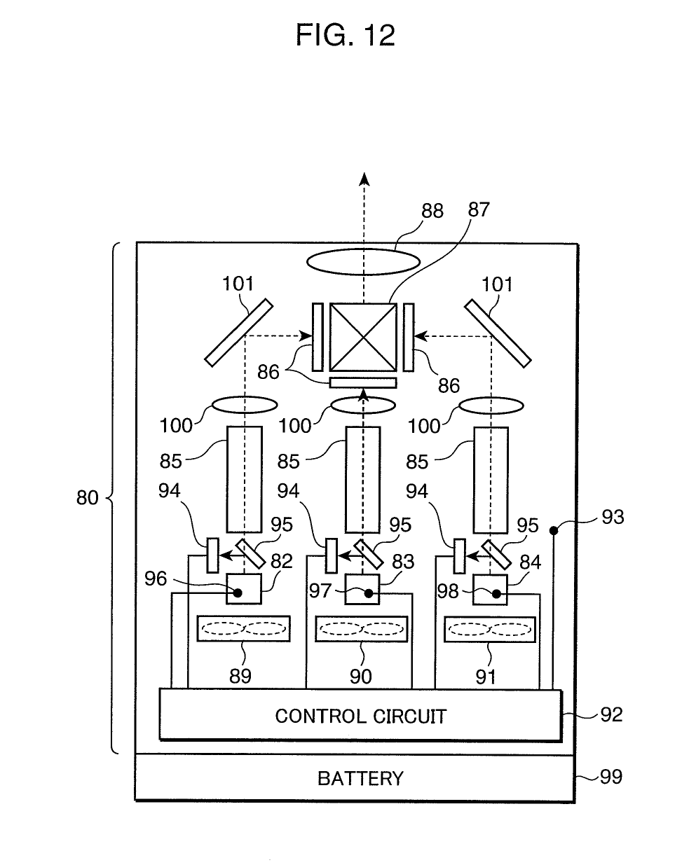

The projection display apparatus in accordance with the fifth embodiment of the invention is briefly described referring to FIG. 12. FIG. 12 is a top plan view of a projection display apparatus 80. Laser light outputted from a red light source 82, a green light source 83, and a blue light source 84 has light amount distributions thereof made uniform by rod integrators 85, and then guided to transparent liquid crystal panels 86 through lenses 100 and reflection mirrors 101. Laser light transmitted through the transparent liquid crystal panels 86 is combined by a combination prism 87, and outputted as an image through an exit lens 88. The apparatus may be driven by a battery 99. In this embodiment, the transparent liquid crystal panels are used for image output. Alternatively, a reflective liquid crystal device, or a device incorporated with a mirror may be used.

In this embodiment, semiconductor lasers are respectively used as the red light source (oscillation wavelength: near 640 nm), and the blue light source 84 (oscillation wavelength: near 440 nm). Since a semiconductor laser has a power-to-light conversion efficiency several times as large as a lamp, the semiconductor laser is advantageous in remarkably reducing the electric power consumption of the apparatus. An SHG (Second Harmonic Generation) laser using wavelength conversion is used as the green light source 83. Since a high-fidelity semiconductor laser capable of emitting green light is not currently available, the SHG laser is used. The SHG laser is more advantageous than a light emitting diode (LED) as other substantially equivalent means for suppressing electric power consumption in obtaining substantially the same green light output.

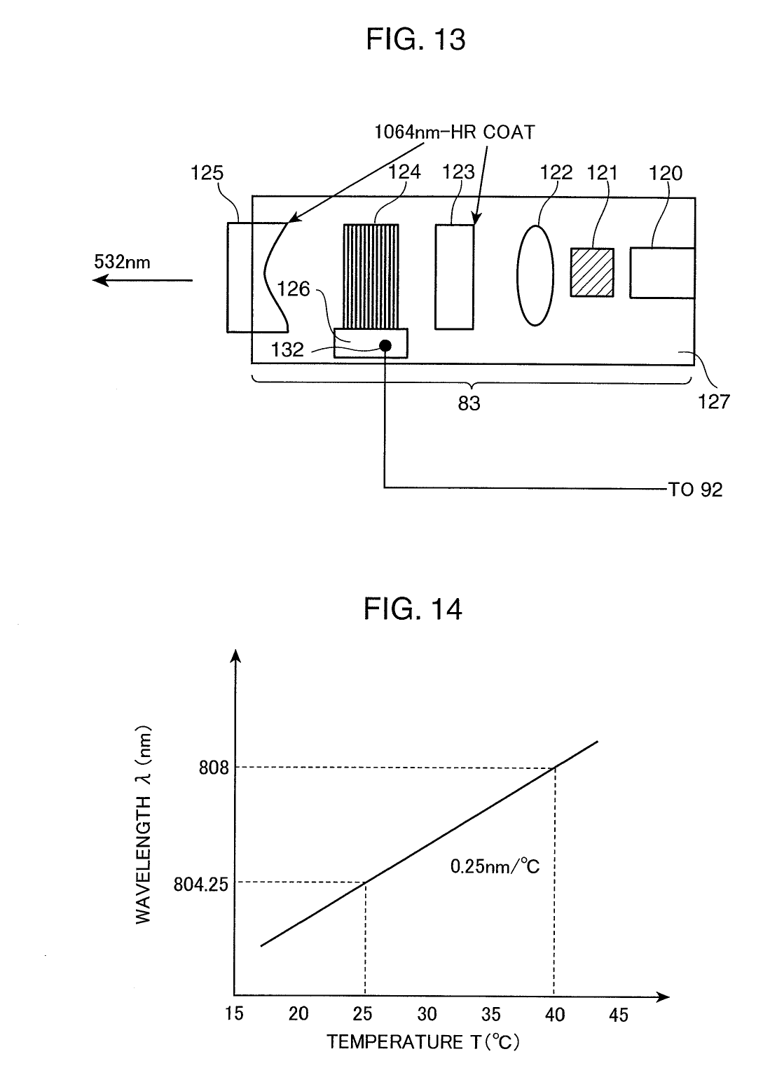

FIG. 13 is a diagram showing an arrangement of an SHG laser to be used as the green light source 83. The SHG laser includes a pumping semiconductor laser 120 for exciting a solid-state laser 123, a grating 121 for locking the oscillation wavelength of the pumping semiconductor laser 120, a lens 122 for condensing light, a solid-state laser 123, a quasi phase matching wavelength converting element 124, a wavelength converter temperature monitor 132, an output mirror 125, a heating device 126, and a frame member 127.

Laser light outputted from the pumping semiconductor laser 120 is absorbed by the solid-state laser 123, which, in turn, outputs laser light (fundamental light) of 1064 nm wavelength. One surface of each of the solid-state laser 123 and the output mirror 125 is formed with an HR coat for reflecting laser light of 1064 nm wavelength. The fundamental light outputted from the solid-state laser 123 is resonated in a resonator constituted of the output mirror 125 and the solid-state laser 123. The fundamental light in the resonator is inputted to the wavelength converting element 124, which, in turn, outputs green laser light of 532 nm wavelength, as second harmonic. The internally resonant SHG laser to be used in this embodiment is compact and has a high output power, and is suitable to be loaded in a compact device.

As described above, the projection display apparatus in this embodiment is incorporated with a light source whose oscillation wavelength spectrum is restricted, such as a semiconductor laser and an SHG laser. Accordingly, the above arrangement is advantageous in facilitating designing an optical component, as compared with an arrangement using a lamp. Thus, the optical system can be miniaturized, and the apparatus can be miniaturized.

Heat in the light sources 82 through 84 is dissipated by fans 89 through 91. A Peltier element may be used as temperature controlling means for a light source. However, the electric power consumption in using a Peltier element may become several ten watts depending on an ambient temperature. On the other hand, in the case where the fans 89 through 91 are used, the fans 89 through 91 may be driven by 1 W or less per device. This is significantly advantageous in suppressing electric power consumption. Thus, use of the fans 89 through 91 allows for battery driving of the projection display apparatus.

As described above, the advantage of using the fans 89 through 91 for dissipating heat from the light sources 82 through 84 is great, but temperature control of the light sources is required, because the oscillation wavelength or the output of the semiconductor lasers used as the light sources 82 and 84 may vary depending on a temperature change. Concerning the SHG laser used as the green light source 83, the phase matching wavelength of the wavelength converting element 124, or the oscillation wavelength and the output of the pumping semiconductor laser 120 may vary depending on a temperature change. In view of the above, it is desirable to stabilize the output power, while keeping the light source temperature in a predetermined temperature zone.

The output powers of the light sources 82 through 84 are stabilized by an output stabilizing mechanism. The output stabilizing mechanism is realized by allowing a part of light separated by beam splitters 95 disposed in front of the light sources 82 through 84 to be incident onto PDs (Photodetectors) 94, and controlling currents to be supplied to the light sources 82 through 84 while monitoring the output of light received on the PDs 94 by a control circuit 92. The light output is controlled by the control circuit 92 so that the light output coincides with a predetermined target output. The target output is defined, considering a change in oscillation wavelength of a semiconductor laser resulting from a temperature change, and color balance.

Drive temperatures (temperatures of the semiconductor lasers) of the light sources are used to monitor a change in oscillation wavelength of the light sources resulting from a temperature change. Specifically, laser temperature sensors 96 through 98 are disposed near the light sources 82 through 84, respectively. In this embodiment, color balance and a target output are determined based on a condition that the temperature of the semiconductor laser is 40° C. The control circuit 92 is operable to control the rotating numbers of the fans 89 through 91 to keep 40° C. as a reference control temperature.

The reference control temperature 40° C. is determined in light of heat generation from a component, and performances of the fans. Since the fans 89 through 91 are used to dissipate the heat, the reference control temperature is required to be set to a value larger than 25° C. as an average temperature. An excessively high reference control temperature may lower the output of the light source, and increase a drive current to be supplied to the light source, which may resultantly increase the electric power consumption.

Next, a control operation to be performed at a startup time of the projection display apparatus is described. As described above, the light sources are controlled based on 40° C. as the reference control temperature. Accordingly, it is desirable to raise the light source temperature to 40° C. as soon as possible in starting up the apparatus in a low temperature condition. First, temperature control on a semiconductor laser used as the light source 82, 84 is described. In this embodiment, a room temperature monitoring device 93 is installed, and the temperature of the light source 82, 84 i.e. a semiconductor laser is controlled, using a value detected by the room temperature monitoring device 93.

A thermistor is used as the room temperature monitoring device 93. A thermistor is effective as inexpensive temperature controlling means. In the case where a room temperature is detected by the room temperature monitoring device 93, and the control circuit 92 judges that the detected room temperature is equal to or lower than the reference control temperature 40° C., a signal requesting suspending rotation of the fan 89, 91 is outputted to set the temperature of the light source 82, 84 to 40° C. Simultaneously, a current of a value equal to a maximum value of a rated current is supplied from the control circuit 92 to the semiconductor laser i.e. the light source 82, 84 to rapidly raise the temperature of the semiconductor laser to 40° C. The temperature of the light source 82, 84 during the heating operation is fed back from the laser temperature sensor 96, 98 to the control circuit 92. When the temperature of the light source 82, 84 becomes close to 40° C., a control operation of rotating the fan to keep the temperature at a constant value is performed. In this embodiment, the control operation is performed based on a timing when the temperature of the light source 82, 84 reaches 40° C. from a room temperature 25° C. Alternatively, the reference control temperature may be properly set, considering the performance of the fan 89, 91, and the heat generation amount of the light source.

Next, a method for starting up an SHG laser used as the green light source 83 in this embodiment is described. First, a temperature characteristic of an SHG laser is described referring to FIGS. 14 through 16. FIG. 14 is a diagram showing a temperature characteristic of the oscillation wavelength of the pumping semiconductor laser 120. As shown in FIG. 14, the oscillation wavelength of the pumping semiconductor laser 120 is changed by 0.25 nm per 1° C. The solid-state laser 123 has a characteristic that light of 808±1 nm wavelength is efficiently absorbed, and fundamental light of 1064 nm wavelength is outputted. Accordingly, it is desirable to lock the oscillation wavelength of the pumping semiconductor laser 120 in the vicinity of 808 nm.

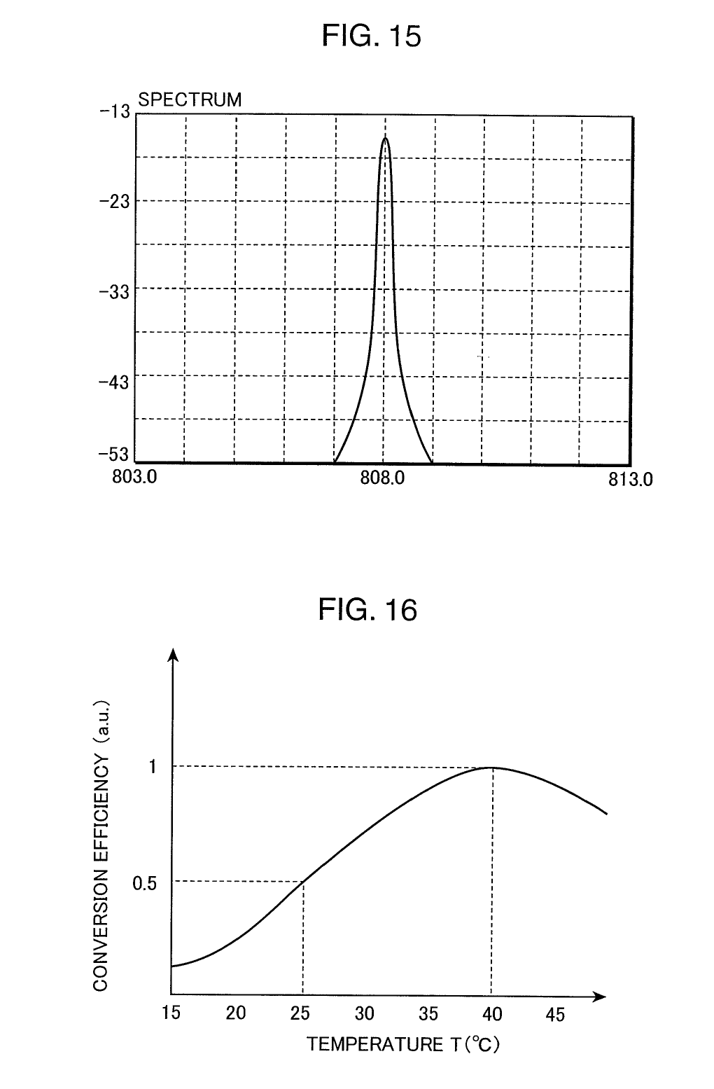

In view of the above, in this embodiment, the grating 121 is used to lock the wavelength of the pumping semiconductor laser 120. In the case were the grating 121 is used, a part of light of 808 nm wavelength out of the laser light emitted from the pumping semiconductor laser 120 is fed back to the pumping semiconductor laser 120 to lock the wavelength to 808 nm. As a result of this operation, as shown in FIG. 15, the wavelength is locked in a range of 40±10° C. substantially at a single mode. Accordingly, it is necessary to control the temperature of the pumping semiconductor laser 120 in a range from 30 to 50° C.

Next, a temperature characteristic of the wavelength converting element 124 is described referring to FIG. 16. In this embodiment, an Mg-doped lithium niobate (hereinafter, called as Mg:LiNbO₃) substrate is used as the quasi phase matching wavelength converting element 124. A cyclic polarization inversion region is formed on the Mg:LiNbO₃ substrate to enhance the wavelength conversion efficiency from fundamental light (1064 nm) to second harmonic (532 nm). As other example of the wavelength converting element, a KTP substrate may be used. However, since an Mg:LiNbO₃ substrate has a larger conversion efficiency from fundamental light to harmonic, the allowable range of the phase matching wavelength can be increased, not to mention miniaturization of the wavelength converting element 124, because the length of the wavelength converting element 124 can be reduced.

FIG. 16 is a diagram showing a temperature characteristic versus conversion efficiency, in the case where the length of the wavelength converting element 124 is 0.5 mm. Referring to FIG. 16, the horizontal axis indicates a temperature of the wavelength converting element 124, and the vertical axis indicates a conversion efficiency from fundamental light to second harmonic. As is obvious from FIG. 16, the conversion efficiency of the wavelength converting element 124 varies depending on a temperature. The wavelength converting element 124 used in this embodiment is configured to maximize the conversion efficiency at 40° C.

As described above, in the case were an SHG laser is used, it is necessary to consider the temperature characteristics of the pumping semiconductor laser 120 and the wavelength converting element 124. Generally, it is often the case that the pumping semiconductor laser 120 and the wavelength converting element 124 are used in a predetermined temperature condition by using a device such as a Peltier element. Use of a Peltier element or a like device, however, may increase electric power consumption, and increase heat generation. In view of this, in this embodiment, the temperatures of the pumping semiconductor laser 120 and the wavelength converting element 124 are controlled by using the fan 90.

Use of the fan 90, however, requires control of an SHG laser against temperature change. In particular, control at a startup time of the apparatus is important. In order to expedite a startup operation of a projection display apparatus, first, it is necessary to set the temperature of the pumping semiconductor laser 120 in a range from 30 to 50° C. Therefore, in the case where the usage environment temperature is lower than 30° C., at a startup time of the apparatus, a constant current near a maximum rated current is supplied from the control circuit 92 to the pumping semiconductor laser 120 to heat the pumping semiconductor laser 120, followed by supply of a drive current for control of output stabilization after the temperature of the green light source 83 has reached near 40° C. The operation of the fan 90 is suspended at the startup time to expedite the temperature increase of the pumping semiconductor laser 120 at the startup time of the apparatus in the similar manner as the control for the red semiconductor laser or the blue semiconductor laser.

Next, the temperature of the wavelength converting element 124 is also required to be set to the vicinity of 40° C. Since the temperature of the pumping semiconductor laser 120 is quickly raised by supply of a current, the pumping semiconductor 120 is less likely to be a factor which may retard the startup time in a low temperature condition. However, since the wavelength converting element 124 is not basically a heat generating member, a certain time is required to increase the temperature of the wavelength converting element 124.

In this embodiment, firstly, a maximum rated current is supplied to the pumping semiconductor laser 120 to increase heat generation at a startup time, and temperature increase of the wavelength converting element 124 is assisted by the casing member 127 of the SHG laser, which is made of a metal having high heat conductivity such as copper. Secondly, in the case where the usage environment temperature is low, temperature increase of the wavelength converting element 124 is expedited by the heating device 126. An example of the heating device 126 is an electric heater. The temperature of the wavelength converting element 124 is checked by the wavelength converter temperature monitor 132, and a current to be supplied to the electric heater is controlled by the control circuit 92. Use of the electric heater enables to raise the temperature of the wavelength converting element 124 to 40° C. within one minute, and enables to perform normal image output within one minute after startup of the apparatus. Thus, in this embodiment, in starting up the projection display apparatus in a low temperature condition, a user is allowed to view an image of a proper color balance within one minute after startup of the apparatus.

In this embodiment, a Fabry-Perot semiconductor laser is used as the pumping semiconductor laser 120, and the transmissive grating 121 is additionally provided. Alternatively, it is also effective to use a DFB (Distributed Feedback) or DBR (Distributed Bragg Reflector) semiconductor laser. Use of a DFB or DBR semiconductor laser is advantageous in stably holding the wavelength without a grating. Although the DFB or DBR semiconductor laser is expensive, as compared with the Fabry-Perot semiconductor laser, the DFB or DBR semiconductor laser is an advantageous light source, if mass production is carried out, and low-cost production is realized.

In this embodiment, a front projection display apparatus is described. Alternatively it is obvious that the invention is also applicable to a rear projection display apparatus. Further alternatively, the invention is also applicable to an illumination device incorporated with a laser.

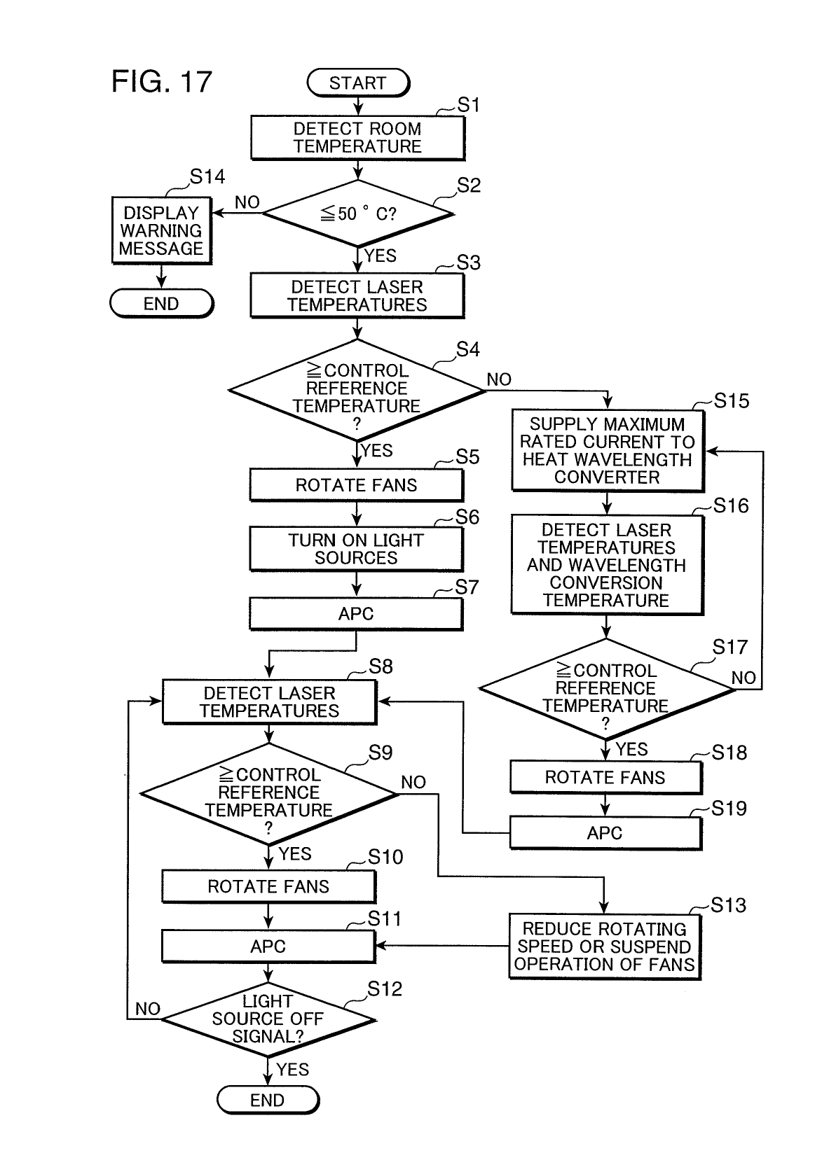

Next, a control method to be performed at a startup time of the projection display apparatus is described in detail. FIG. 17 is a flowchart for describing a control method to be performed at a startup time of the projection display apparatus shown in FIG. 12. The flowchart of FIG. 17 is made based on this embodiment.

In the projection display apparatus, first, the control circuit 92 causes the room temperature monitoring device 93 to monitor a temperature of the environment in which the apparatus is used (Step S1), and judges whether the temperature of the usage environment is equal to or lower than 50° C. (Step S2). If the temperature of the usage environment is over 50° C., a load to the light source is unduly increased. Accordingly, the control circuit 92 is operable to display a message indicating that the apparatus is unusable, and suspends a startup operation of the apparatus (Step S14).

If, on the other hand, the temperature of the usage environment is equal to or lower than 50° C., the control circuit 92 causes the laser temperature sensors 96 through 98 to monitor the temperatures of the light sources 82 through 84 (Step S3), and judges whether the temperatures of the light sources 82 through 84 are equal to or higher than the reference control temperature (Step S4). If it is judged that the temperatures of the light sources 82 through 84 are equal to or higher than the reference control temperature, the control circuit 92 causes the fans 89 through 91 to rotate (Step S5), causes the light sources 82 through 84 to turn on (Step S6), and then, drives the light sources 82 through 84 to perform an APC (Auto Power Control) operation (Step S7). In this embodiment, the reference control temperature is set to 40° C.

If, on the other hand, the temperatures of the light sources 82 through 84 are below the reference control temperature, the control circuit 92 supplies a maximum rated current to the light sources 82 through 84 so that the temperatures of the light sources 82 through 84 are rapidly raised to the reference control temperature (Step S15). If the temperature of the green light source 83 is below the reference control temperature, the control circuit 92 simultaneously causes the heating device 126 to heat the wavelength converting element 124.

Subsequently, the control circuit 92 causes the laser temperature sensors 96 through 98 to check the temperatures of the light sources (semiconductor lasers) 82 through 84, and causes the wavelength converter temperature monitor 132 to check the temperature of the wavelength converting element 124 (Step S16), and judges whether the temperatures of the light sources (semiconductor lasers) 82 through 84 and the wavelength converting element 124 are equal to or higher than the reference control temperature (Step S17). If it is judged that the temperatures of the light sources (semiconductor lasers) 82 through 84 and the wavelength converting element 124 are below the reference control temperature, the control circuit 92 cyclically repeats the operation of Step S15 and thereafter until the temperatures of the light sources (semiconductor lasers) 82 through 84 and the wavelength converting element 124 reach the vicinity of the reference control temperature.

If, on the other hand, the temperatures of the light sources (semiconductor lasers) 82 through 84 and the wavelength converting element 124 are equal to or higher than the reference control temperature, the control circuit 92 causes the fans 89 through 91 to rotate (Step S18), and drives the light sources 82 through 84 to perform an APC operation (Step S19). Heating to the wavelength converting element 124 may be terminated in the above stage, or the temperature of the wavelength converting element 124 may be controlled to retain the reference control temperature.

After the temperatures of the light sources 82 through 84 and the wavelength converting element 124 are set in the vicinity of the reference control temperature, the control circuit 92 causes the laser temperature sensors 96 through 98 to monitor the temperatures of the light sources 82 through 84 (Step S8), and judges whether the temperatures of the light sources 82 through 84 are equal to or higher than the reference control temperature (Step S9). If it is judged that the temperatures of the light sources 82 through 84 are equal to or higher than the reference control temperature, the control circuit 92 causes the fans 89 through 91 to rotate (Step S10). If, an the other hand, it is judged that the temperatures of the light sources 82 through 84 are below the reference control temperature, the control circuit 92 causes the fans 89 through 91 to decelerate the rotating speed thereof or suspend the rotation thereof (Step S13). In this way, the control circuit 92 controls the temperatures of the light sources 82 through 84 while controlling rotation of the fans 89 through 91, and drives the light sources 82 through 84 to perform an APC operation (Step S11).

Subsequently, the control circuit 92 judges whether a predetermined OFF signal to turn off the light sources is inputted. The above operation is continued until a signal requesting turning off the light sources 82 through 84 is supplied (Step S12).

Performing the above startup operation not only enables to rapidly start up the apparatus, but also enables to realize temperature control of the light sources 82 through 84, without using a Peltier element. Accordingly, a user is allowed to view an image having a proper color balance within one minute after startup of the projection display apparatus, in the case where the projection display apparatus is started up in a low temperature condition.

### Sixth Embodiment

In this embodiment, described is a projection display apparatus loaded with an SHG laser incorporated with a UV light source as the heating device 126 in FIG. 13. Since the sixth embodiment is substantially the same as the fifth embodiment in basic construction, detailed description thereof is omitted herein, and a feature of the sixth embodiment is described referring to FIG. 13.

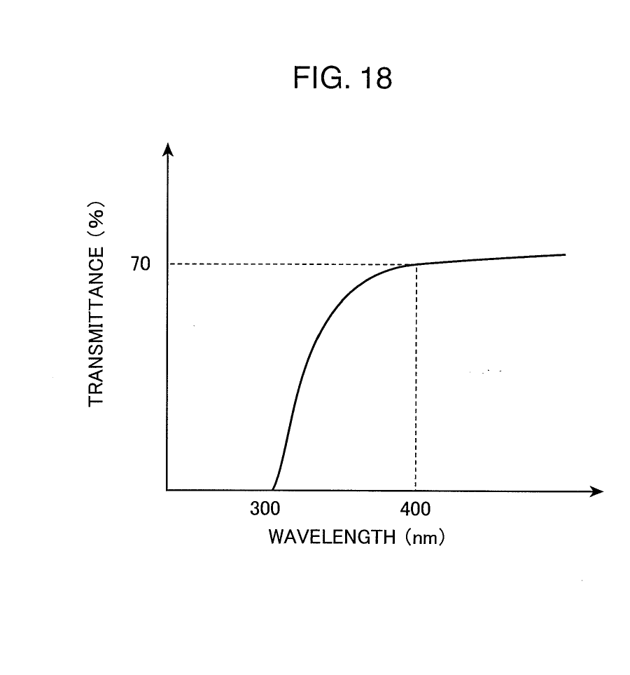

FIG. 18 is a diagram showing a transmittance versus wavelength of an Mg:LiNbO₃ substrate as a wavelength converting element 124. As shown in FIG. 18, the wavelength converting element 124 has an absorption characteristic with respect to light of 400 nm wavelength or less, and the transmittance of the wavelength converting element 124 is lowered, as the wavelength is decreased. In view of this characteristic, in this embodiment, an LED for emitting UV light is used as the heating device 126 of the wavelength converting element 124. Specifically, plural LEDs of 350 nm wavelength are used and embedded in a predetermined position of the heating device 126 shown in FIG. 13. UV light emitted from the LEDs is absorbed in the wavelength converting element 124, and converted into heat.

As a result of the above operation, similarly to the fifth embodiment, irradiation of UV light by the LEDs assists temperature increase of the wavelength converting element 124, in the case where the usage environment temperature at a startup time of the apparatus is low. In this embodiment, LEDs of 350 nm wavelength are used. Alternatively, use of an LED or a semiconductor laser having a shorter wavelength is more advantageous in obtaining the effect.

### Seventh Embodiment

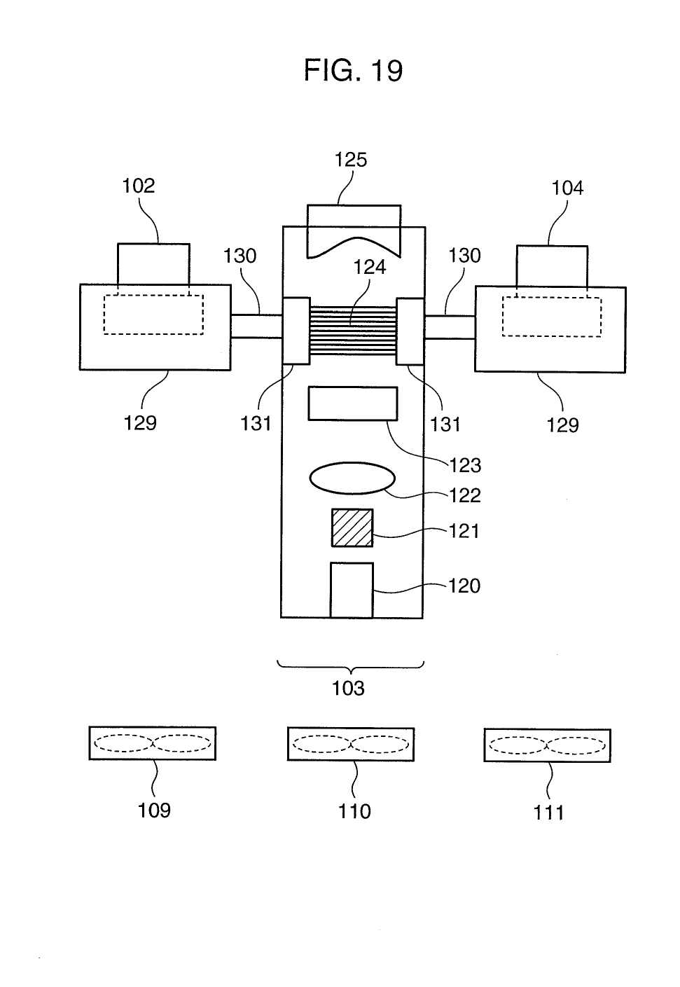

This embodiment is described referring to FIG. 19. FIG. 19 is a diagram enlargedly showing light sources 102 through 104 and peripheral parts thereof in a projection display apparatus in accordance with the seventh embodiment. Since the elements other than the ones shown in FIG. 19 are substantially the same as those of the projection display apparatus shown in FIG. 12, detailed description thereof is omitted herein.

A red semiconductor laser is used as a light source 102 shown in FIG. 19. The red semiconductor laser is fixed to an LD holder 129 made of Cu, and heat generated in the light source 102 is dissipated therefrom, using the LD holder 129. The SHG laser shown in FIG. 13 is used as the light source 103. A blue semiconductor laser is used as the light source 104. Similarly to the red semiconductor laser, the blue semiconductor laser is fixed to an LD holder 129 made of Cu, and heat generated in the light source 104 is dissipated therefrom using the LD holder 129.

In this embodiment, heat generation in the light sources 102 and 104 i.e. the red and the blue semiconductor lasers is utilized as means for assisting temperature increase of the wavelength converting element 124 in starting up the projection display apparatus in a low temperature condition. In starting up the apparatus, in a condition where the usage environment temperature is low, driving of fans 109 through 111 is suspended until a time when the temperature of the wavelength converting element 124 reaches near 40° C., and the temperatures of the red and the blue semiconductor lasers are increased while generating heat. The heat generated in this operation is utilized to raise the temperature of the wavelength converting element 124.

In this embodiment, the wavelength converting element 124 is fixed to element holders 131 made of Cu. Preferably, the element holders 131 and polarization inversion regions formed on the wavelength converting element 124 are contacted with each other. The material of the element holder 131 is preferably a material having a large heat conductivity such as Cu.

The corresponding LD holder 129 and the corresponding element holder 131 are connected by a heat transfer portion 130. The material of the heat transfer portion 130 is a material having a large heat conductivity such as Cu. Use of a heat pipe as the heat transfer portion 130 is advantageous in obtaining the effect. Suspending rotation of the fans 109 through 111 in a low temperature condition, and supplying currents to the red and the blue semiconductor lasers allows the temperatures of the LD holders 129 to reach the vicinity of 40° C. within one minute. Heat transferred from the LD holders 129 to the element holders 131 via the heat transfer portions 130 warms the wavelength converting element 124. Since the size of the wavelength converting element 124 is about several millimeters square, the temperature of the wavelength converting element 124 is easily increased. Normally, it is often the case that the light sources 102 through 104 are disposed close to each other to miniaturize the optical system, utilizing heat generated in the red and the blue semiconductor lasers to heat the wavelength converting element 124 is effective in preventing the size of the apparatus from increasing.

In this embodiment, heat generated in the red and the blue semiconductor lasers is utilized to assist temperature increase of the wavelength converting element 124. Alternatively, a heat generating component in the apparatus may be used. An example of the heat generating component is a circuit component to be used in a control circuit.

### Eighth Embodiment

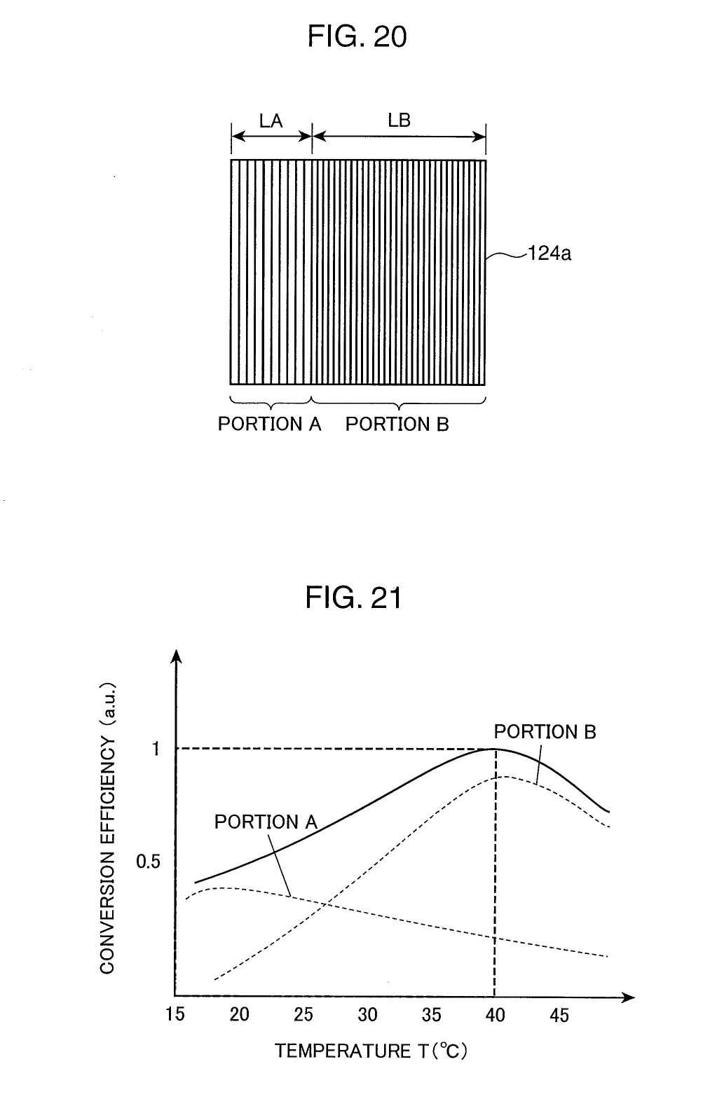

In this embodiment, described is an example, wherein a certain measure is taken for a wavelength converting element in starting up an apparatus in a low temperature condition. A wavelength converting element to be used in a projection display apparatus in accordance with the eighth embodiment is described referring to FIGS. 20 and 21. Since parts other than the wavelength converting element shown in FIG. 20 are substantially the same as the corresponding parts in the projection display apparatus shown in FIG. 12, detailed description thereof is omitted herein.

As shown in FIG. 20, a wavelength converting element 124a used in this embodiment is constituted of two parts i.e. a polarization inversion region as a portion “A” and a polarization inversion region as a portion “B”. The portion “A” and the portion “B” are different from each other in polarization inversion cycle. The polarization inversion cycle of the portion “A” is longer than that of the portion “B”. The length LA of the portion “A” is shorter than the length LB of the portion “B”.

In the case where the polarization inversion cycle defined in a wavelength converter is single, as shown in FIG. 16, wavelength conversion efficiency with respect to a temperature has a Gaussian distribution. However, as described in this embodiment, attaching the portion “B” having a shorter polarization inversion cycle to the portion “A” having a longer polarization inversion cycle enables to perform desirable wavelength conversion even in a low temperature condition. As shown by the broken line in FIG. 21, the portion “A” has a characteristic that the wavelength conversion efficiency of the portion “A” is larger than that of the portion “B”, in the case where the temperature of the wavelength converting element 124a is low. Also, since the length of the portion “A” is shorter than the length of the portion “B”, the portion “A” has a characteristic that allowance with respect to a temperature is larger than that of the portion “B”, although the wavelength conversion efficiency of the portion “A” is smaller than that of the portion “B”. Accordingly, it is possible to output G light in a low temperature condition. Combination of the characteristics of the portions “A” and “B” corresponds to an actual wavelength conversion characteristic of the wavelength converting element, which is shown by the solid line in FIG. 21.

In this embodiment, preferably, the length of the portion “B” is 1.0 mm or less. In the case where the length of the portion “B” is 1.0 mm, the range of allowance of wavelength conversion efficiency with respect to a temperature is about 15° C. In this embodiment, the allowance is determined based on a point where the wavelength conversion efficiency reduces to one-half. In other words, a temperature change of 7.5° C. indicates that the wavelength conversion efficiency is reduced to one-half.

Extending the length of the wavelength converting element resultantly reduces the range of allowance with respect to a temperature, because the temperature allowable range is inversely proportional to the length of the wavelength converting element. Specifically, changing the length of the wavelength converting element from 1.0 mm to 2.0 mm results in changing the range of allowance with respect to a temperature from 15° C. to 7.5° C., which requires high-precision temperature control. Extending the length of the wavelength converting element results in increasing the transmittance loss in a resonator. Accordingly, extending the length of the wavelength converting element is not significantly effective in enhancing wavelength conversion efficiency from fundamental light to G light. On the other hand, the length of the portion “B” of less than 0.3 mm may excessively reduce the wavelength conversion efficiency with respect to a set temperature, which is not preferable. In view of the above, the length of the portion “B” is preferably in the range from 0.3 to 1.0 mm.

Since it is important to increase the allowable range with respect to a temperature, as compared with the magnitude of wavelength conversion efficiency, it is desirable to set the length of the portion “A” in the range from about 0.1 to 0.2 mm. For instance, in the case where the length of the wavelength converting element is 0.2 mm, the allowable range with respect to a temperature is 75° C. Accordingly, in the case where a wavelength converting element is fabricated by setting a temperature where the conversion efficiency of the portion “A” is maximized to 20° C., G light emission can be secured even in a condition where the room temperature falls below 0° C. Considering the above, it is preferable to set the length (LA+LB) of the entirety (portion “A” and portion “B”) of the wavelength converting element 124a not less than 0.4 mm and not more than 1.2 mm.

Considering an investigation result of the element length of the quasi phase matching wavelength converting element in the first embodiment, it is more preferable to set the length of the portion “B” not less than 0.3 mm and not more than 0.6 mm. In this case, assuming that the length of the portion “A” is not less than 0.1 mm and not more than 0.2 mm, it is preferable to set the length (LA+LB) of the entirety (portion “A” and portion “B”) of the wavelength converting element 124a not less than 0.4 mm and not more than 0.8 mm.

As described above, in this embodiment, the allowance of the portion “A” (first polarization inversion region) with respect to a temperature is increased, as compared with that of the portion “B” (second polarization inversion region), and the wavelength conversion efficiency of the portion “A” in a low temperature condition is increased, as compared with that of the portion “B”. Accordingly, this arrangement enables to increase the temperature allowable range, and shorten a startup time of the apparatus, even in the case where the usage environment temperature in starting up the apparatus is low.

### Ninth Embodiment

In the ninth through the twelfth embodiments, described are arrangements of a solid-state laser apparatus capable of outputting high-output visible laser light by generating fundamental laser light by excitation of a solid-state laser medium by a semiconductor laser array element, and converting the fundamental laser light into harmonic laser light by a wavelength converting element and a display apparatus incorporated with the solid-state laser apparatus.

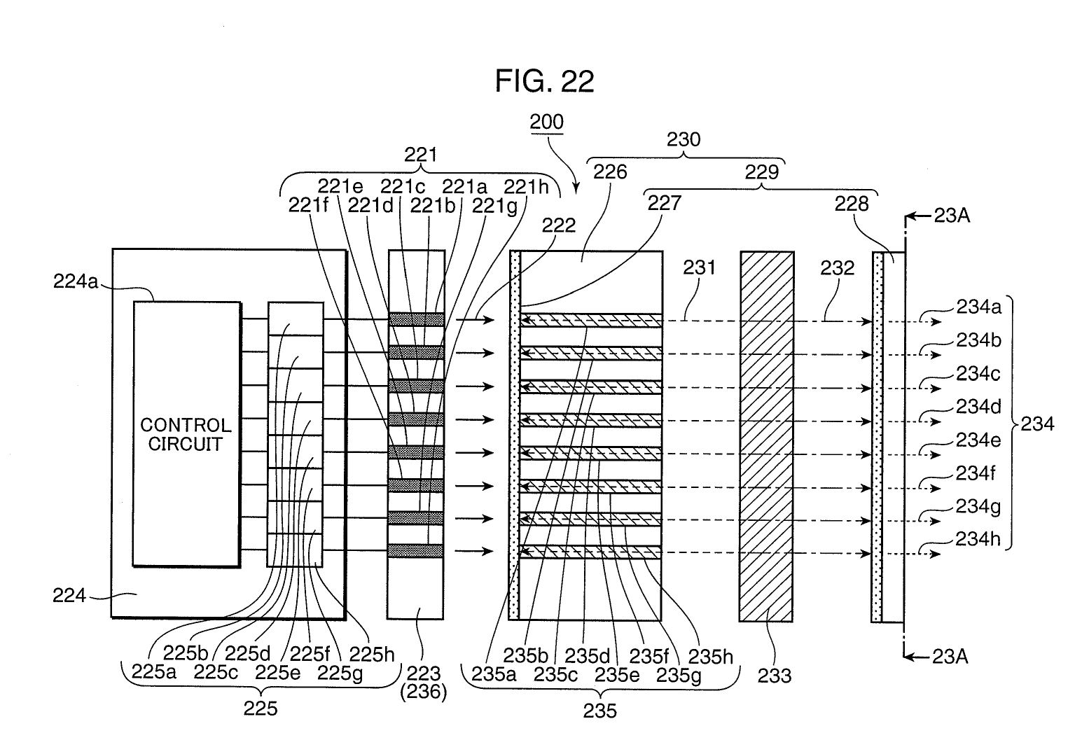

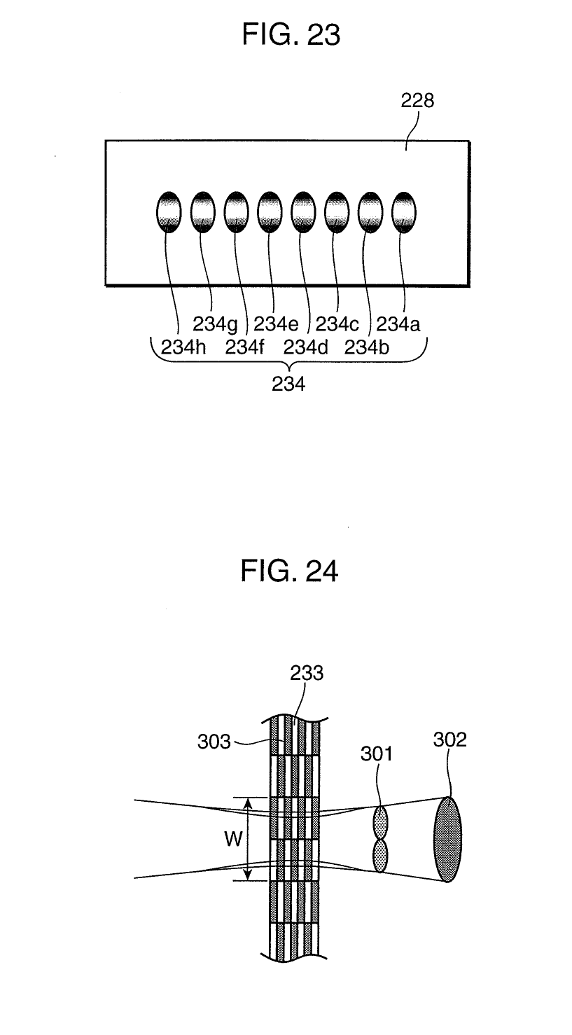

FIGS. 22 through 24 are schematic diagrams of a solid-state laser source 200 as a solid-state laser apparatus in accordance with the ninth embodiment of the invention. FIG. 22 is a top plan view of a schematic arrangement of the solid-state laser light source 200 in this embodiment. FIG. 23 is a side view of the solid-state laser light source 200 viewed from a plane taken along the line 23A-23A in FIG. 22. FIG. 24 is an enlarged view of a wavelength converting element 233 shown in FIG. 22.

As shown in FIG. 22, the solid-state laser light source 200 as a solid-state laser apparatus includes a semiconductor element (semiconductor laser light source) 223 for emitting excitation beams 222 from active regions 221 (e.g. eight active regions 221a, 221b, 221c, 221d, 221e, 221f, 221g, and 221h), and a controller 224 for controlling the excitation beams 222 by driving the active regions 221 of the semiconductor element 223 independently of each other. The active regions 221 are driven independently of each other by a control circuit 244a and power sources 225 (e.g. eight power sources 225a, 225b, 225c, 225d, 225e, 225f, 225g, and 225h) provided in the controller 224.

The solid-state laser light source 200 further includes a solid-state laser element 230 and the wavelength converting element 233. The solid-state laser element 230 includes a solid-state laser medium 226 at least having a part thereof excited by the excitation beams 222; and a laser resonator 229 constituted of an end surface 227 opposing to the semiconductor element 223 of the solid-state laser medium 226, and an output mirror 228. The wavelength converting element 233 is disposed in the laser resonator 229, and is operable to convert fundamental beams 231 oscillated by the solid-state laser element 230 into harmonic beams 232.

The solid-state laser light source 200 is operable to output the harmonic beams 232 from the output mirror 228 as output beams 234 (e.g. one of eight output beams 234a, 234b, 234c, 234d, 234e, 234f, 234g, and 234h). In the output, the positions of generating portions 235 (e.g. one of eight generating portions 235a, 235b, 235c, 235d, 235e, 235f, 235g, and 235h) for generating the fundamental beams 231 of the solid-state laser medium 226 excited by the excitation beams 222 are timewise changed, and the harmonic beams 232 as multi-beams are emitted. The harmonic beams 232 are extracted as the output beams 234 of the solid-state laser light source 200 by the output mirror 228.

The excitation beams 222 are divergently emitted from the semiconductor element 223. Accordingly, the excitation beams 222 are converted into parallel light through an optical system (not shown) such as a cylindrical lens, and then incident into the solid-state laser medium 226 to excite the solid-state laser medium 226.

In the above arrangement, as shown in FIG. 23, in the case where all the active regions 221 of the semiconductor element 223 are driven by the power sources 225, the output beams 234 (e.g. eight output beams 234a, 234b, 234c, 234d, 234e, 234f, 234g, and 234h) are outputted from the output mirror 228 as multi-beams constituted of eight beams.

For instance, in the case where 1 W green laser light is required as a light source in a display apparatus in outputting 0.5 W green laser light of 532 nm wavelength from one beam, the required 1 W green laser light is obtained by using any two beams out of the eight beams of the output beams 234. The two beams are obtained by driving two of the active regions 221 of the semiconductor element 223 shown in FIG. 22 by two of the power sources 225. In the driving, since the other six active regions 221 are not driven by the other six power sources 225, the other six active regions 221 are not activated. Further, corresponding regions of the solid-state laser element 230 which are supposed to be excited by the excitation beams 222 to be emitted in response to activation of the other six active regions 221, and regions on the wavelength converting element 233 corresponding to the regions are also not activated.

Accordingly, after the above operation is performed for a predetermined time, during a succeeding predetermined time, any two of the active regions 221 other than the aforementioned two active regions 221 activated in the preceding predetermined time are activated. Thus, the output beams 234 are obtained from different positions shown in FIG. 23 by the excitation beams 222 from the newly activated active regions 221.

In the above arrangement, the positions of the generating portions 235 for generating the fundamental beams 231 of the solid-state laser medium 226 excited by the excitation beams 222 are timewise changed, and the solid-state laser light source 200 is operable to emit the harmonic beams 232 as multi-beams. This enables to realize the long-life and high-fidelity solid-state laser light source 200, because the same region is not continuously activated, and a region which has been activated for a predetermined time is not activated for a succeeding predetermined time.

The output beams 234 having the same output are outputted as multi-beams by timewise changing the regions where the fundamental beams 231 of the solid-state laser medium 226 are generated, and the regions where the harmonic beams 232 of the wavelength converting element 233 are generated, and high-output green laser light in the order of watts is stably obtained. Displaying an image or the like by using the solid-state laser light source 200 is advantageous in displaying an image with reduced speckle noise, because the harmonic beams 232 as multi-beams are emitted from different positions each time a predetermined time is elapsed.

The heat distribution in the laser resonator 229 is changed, and the space distribution of the oscillation mode is changed, by timewise changing the regions of the solid-state laser medium 226 where the fundamental beams 231 are generated. As a result of this operation, the oscillation wavelength spectrum of the solid-state laser light source 200 is increased, and coherence of laser light is lowered. Accordingly, interference can be suppressed, and speckle noise can be reduced. Since a change in heat distribution is utilized, a modulation speed of 60 Hz or more is required as a modulation frequency. If the modulation frequency is equal to or smaller than 60 Hz, heat variation is reduced, and an increase in spectrum is reduced.

Also, the output of the harmonic beams 232 can be stabilized by timewise changing the regions of the solid-state laser medium 226 where the fundamental beams 231 are generated in the following manner. In the case where the harmonic beams 232 are generated in the laser resonator 229, the harmonic beams 232 generated in the laser resonator 229 are reflected on any one of resonator mirrors (the end surface 227 and the output mirror 228), and transmitted through a non-linear crystal again. While being transmitted through the crystal, the harmonic beams 232 are converted into the fundamental beams 231 again by a non-linear optical effect, and output variation may occur by interference with the fundamental beams 231 resonated in the laser resonator 229. This problem is generally called “Green Problem”.

The arrangement of this embodiment is also effective in suppressing output instability resulting from inverse conversion of the harmonic beams 232. In this embodiment, the laser generating position in the laser resonator 229 is partially changed. Setting a frequency to be used in the change to not smaller than 60 Hz and not larger than a relaxation oscillation frequency (e.g. not larger than several kHz in the case of Nd system solid-state laser) of the solid-state laser medium 226 enables to constantly keep the oscillation state of the laser resonator 229 in an unstable condition. The unstable condition is advantageous in eliminating the output instability by an interference effect, because the interference between fundamental beams 231 generated by inverse conversion, and the original fundamental beams 231 is significantly suppressed.

Changing an output at the same position requires maintaining an on/off state, which may lower the average output. On the other hand, as proposed in the arrangement of this embodiment, constantly setting the laser resonator 229 in an emission state, and timewise changing the emission position by timewise changing the laser generating position enables to stabilize the output while securing a high-output characteristic. Specifically, stabilized harmonic output is obtained by constantly changing the emission position of the solid-state laser medium 226 in such a manner that one of the regions is constantly excited, and the same region is not continuously excited for e.g. 1 ms or longer with a frequency larger than the relaxation oscillation frequency of the solid-state laser medium 226.

Also, as shown in FIG. 24, speckle noise can be reduced by using a non-linear optical element having a cyclic polarization inversion structure 303, as the wavelength converting element 233. Since a large non-linear constant can be utilized by using an MgO:LiNbO₃-substrate, an MgO:LiTaO₃-substrate or a like substrate having a cyclic polarization inversion structure as the wavelength converting element 233, high efficiency is obtained.

Specifically, as shown in FIG. 24, the wavelength converting element 233 is constructed in such a manner that phases of the cyclic polarization inversion structures 303 are partially different from each other. For instance, it is preferable to alternately arrange the polarization inversion structures 303 by displacing the phase of one of the polarization inversion structures 303 from the phase of the other of the polarization inversion structures 303 by 180 degrees. This enables to emit output beams as multi-beams by retaining the fundamental beam 302 passing through the wavelength converting element 233 unchanged, and differentiating the phases of the harmonic beams 301 to be generated, depending on a laser generating position. In this way, outputting beams of a short wavelength to be generated as a multi mode beam, in addition to timewise changing the generating position of fundamental beams is more advantageous in increasing a change in beams and reducing speckle noise.

The cyclic polarization inversion structure 303 is formed with a cyclic polarization inversion region with respect to the light propagating direction (leftward and rightward directions in FIG. 24). The polarization inversion region is divided into plural portions in a direction perpendicular to the light propagating direction. The polarization inversion cycles of the plural portions are substantially equal to each other, and the phases of the polarization inversion cycles are different from each other at the portions.

It is desirable to set the width “W” of the polarization inversion structures 303 whose phases are aligned to each other to a value smaller than the beam diameter of the fundamental beam 302 to be resonated in the laser resonator 229, and ten times or more of the polarization inversion cycle. Allowing the fundamental beam 302 to transverse the polarization inversion portions where the phases are different from each other enables to generate the harmonic beams 301 whose phases are different from each other i.e. multi-beams. If the polarization inversion structures have a width equal to or smaller than ten times of the polarization inversion cycle, efficiency is lowered by interference between adjoining beams.

If a phase difference between the adjoining portions of the polarization inversion structures 303 is Λ/2 (where Λ is the wavelength of the harmonic beam 301), the harmonic beam 301 has phases inverted to each other, and turn into two beams. With a phase difference of Λ/4, multi-beams are also generated by beam interference. In this way, the sectional area of a beam can be increased by turning the harmonic beams 301 into multi-beams. Thereby, the power density of the harmonic beams 301 can be reduced, and resistance against a high-output power can be increased. Further, as described above, there is a phenomenon that the output may be unstable by interference of the harmonic beams 301 in the laser resonator 229. However, the interference degree is lowered, and the output is stabilized by turning the harmonic beams 301 into a multi-mode beam.

There are proposed some arrangements concerning a position where a phase difference of the cyclic polarization inversion structure 303 is defined. As one arrangement, portions having different phases in a fundamental beam to be generated by one excitation beam are defined in the wavelength converting element 233. For instance, in the case where the beam interval of the fundamental beam 302 is 250 μm, the phase of the polarization inversion structure 303 is displaced by Λ/2 per 250 μm. In this case, adjusting the position of the wavelength converting element 233 with respect to the solid-state laser medium 226 so that a step portion corresponding to a phase difference is substantially aligned with the center of the fundamental beam 302 enables to generate a multi-mode beam, in which a generated beam turns into two beams.

As other arrangement, cyclic polarization inversion structures whose phases are different from each other with respect to each of the fundamental beams 302 are provided in the wavelength converting element 233. In this arrangement, the active regions 221 of the semiconductor element 223 are simultaneously driven and used to excite the solid-state laser medium 226. In this arrangement, the generating portions 235 of the solid-state laser medium 226 are excited, and the interference pattern is complicatedly changed by differentiating the phases of the harmonic beams 301 generated from the respective generating portions 235. This is advantageous in increasing an effect of suppressing speckle noise.

The above arrangements may be combined. Specifically, a polarization inversion structure having a phase difference is formed in each of the fundamental beams 302, and the phases of the polarization inversion structures are differentiated from each other. This is also advantageous in increasing a timewise change with respect to a phase difference in multi-beams, and increasing an effect of suppressing speckle noise.

In the case where wavelength conversion is performed in the laser resonator 229, the laser output may become unstable by interference between the generated short wavelength beams. On the other hand, in this embodiment, since the oscillation mode in the laser resonator 229 can be changed by timewise changing positions where the multi-beams are generated, unstable laser output can be eliminated while suppressing interference.

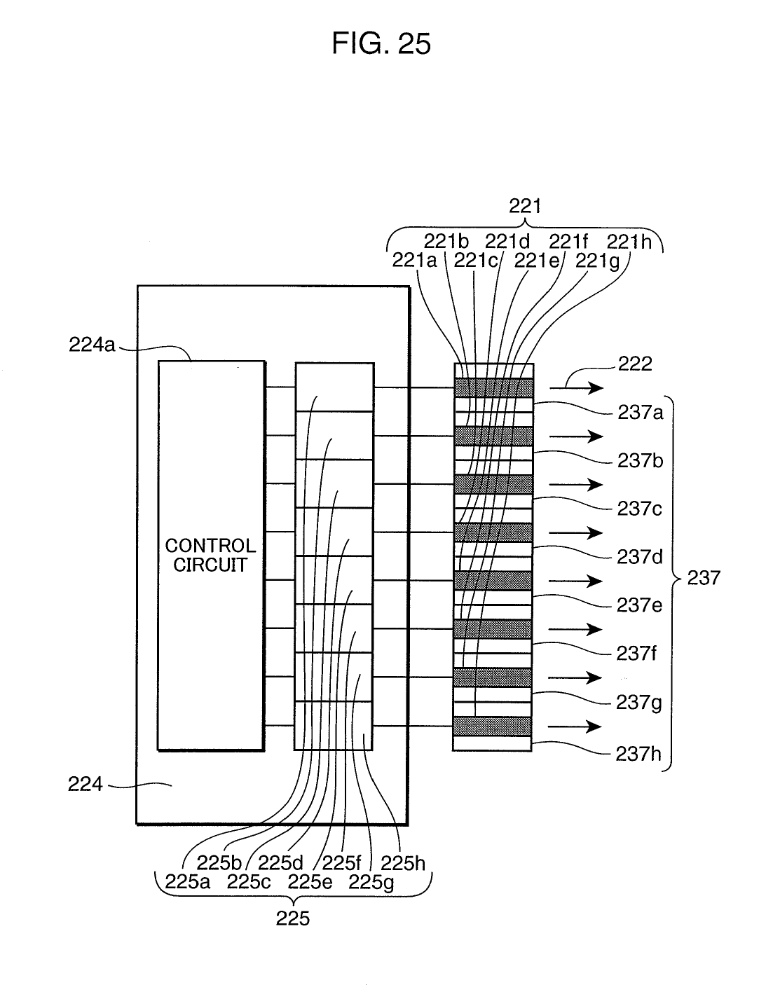

In this embodiment, as shown in FIG. 22, the semiconductor element 223 is constituted of the semiconductor laser array element 236 having the active regions 221 which are allowed to be driven independently of each other. The embodiment is not specifically limited to the above example. For instance, as shown in FIG. 25, parallel-arranged semiconductor laser elements 237 (e.g. eight semiconductor laser elements 237a, 237b, 237c, 237d, 237e, 237f, 237g, and 237h) for emitting excitation beams 222 from corresponding active regions 221 (e.g. eight active regions 221a, 221b, 221c, 221d, 221e, 221f, 221g, and 221h) may be used as the semiconductor element 223. The modification enables to stably obtain high-output green laser light in the order of watts. Further alternatively, a supersaturated absorbent may be provided in the laser resonator 229. The modification is advantageous in generating an output of a high peak power.

Next, described is an example of an arrangement of emitting the harmonic beams 232 as multi-beams by timewise switching between the active regions 221, and timewise changing the position of the generating portions 235 where the fundamental beams 231 are generated.

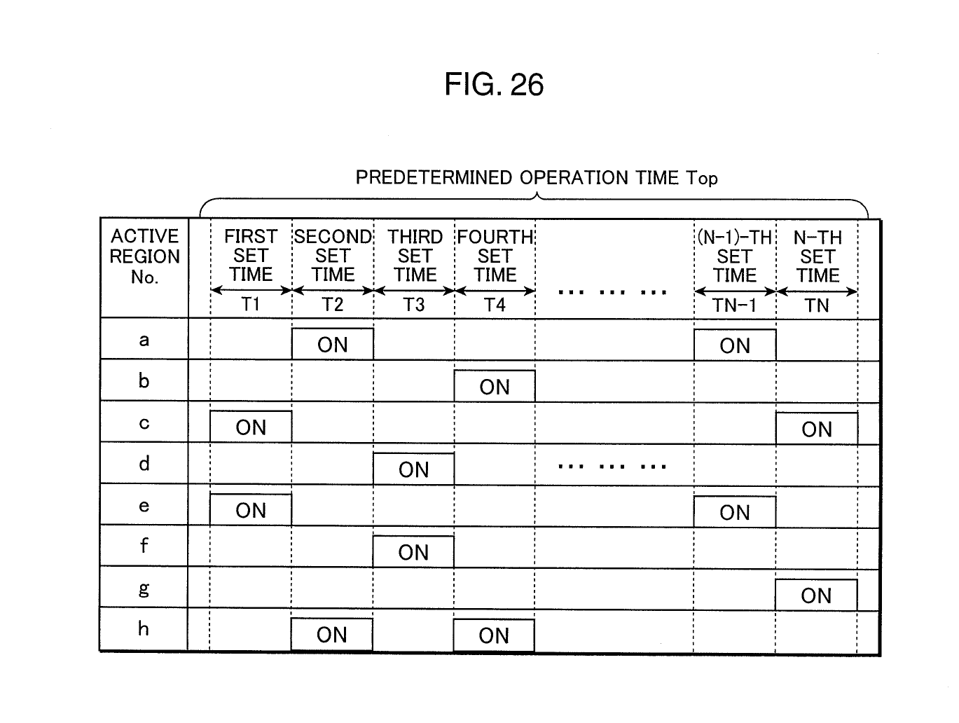

FIG. 26 is a time chart showing an operation to be performed by the solid-state laser light source 200 in this embodiment. Referring to FIG. 26, No. of the active region 221 corresponds to the alphabets “a” through “h” of the active regions 221a through 221h as the active regions 221 of the semiconductor laser array element 236 shown in FIG. 22. FIG. 26 also shows which active region 221 is activated by the solid-state laser light source 200 in which one of set times in a predetermined operation time Top. The predetermined operation time Top is divided into the first set time T1 through the N-th set time TN in the unit of set time T. The frequency “f” at which the set time is switched is an inverse number of the set time T.

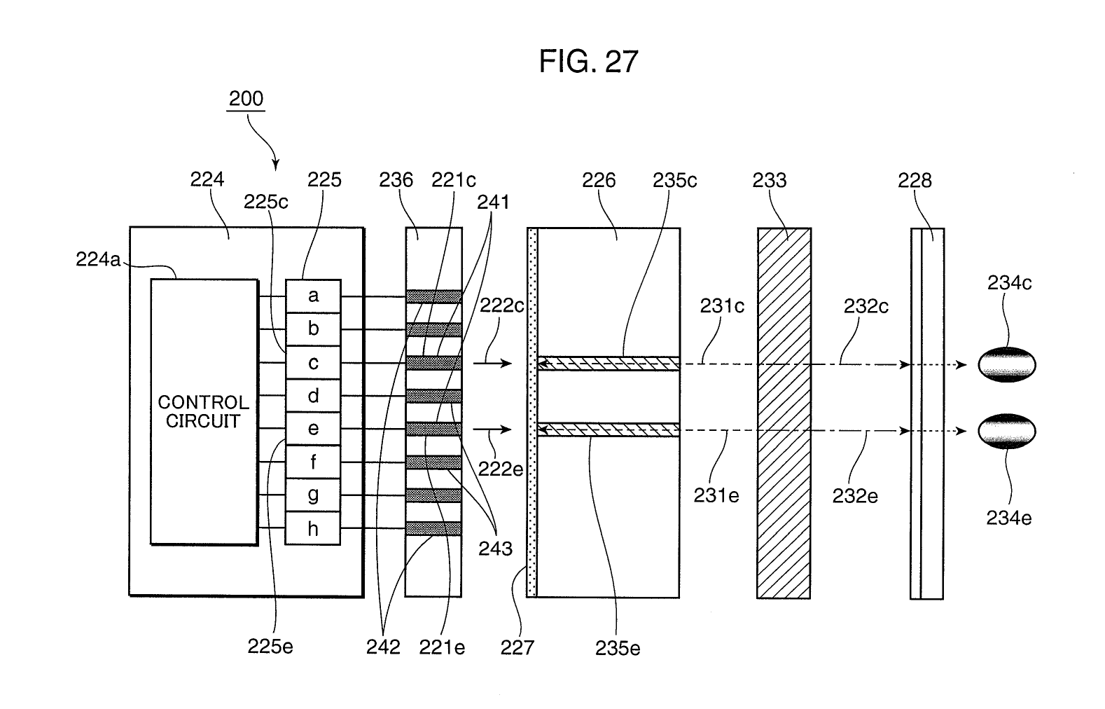

FIG. 27 is a schematic construction diagram showing the solid-state laser light source 200 for emitting multi-beams in the first set time T1, and having the same arrangement as the solid-state laser light source 200 shown in FIG. 22. As shown in FIG. 27, in the first set time T1, the active regions 221c and 221e of the semiconductor laser array element 236 are respectively driven by the power sources 225c and 225e, and excitation beams 222c and 222e are incident into the solid-state laser medium 226. Then, the generating portions 235c and 235e of the solid-state laser medium 226 are respectively excited by the excitation beams 222c and 222e, and fundamental beams 231c and 231e are oscillated. The fundamental beams 231c and 231e are converted into harmonic beams 232c and 232e by the wavelength converting element 233, and multi-beams constituted of two beams are outputted as the output beams 234c and 234e.

As described above, referring to FIG. 27, the two active regions 221c and 221e are selected to output two beams, and the two output beams 234c and 234e are outputted as multi-beams of the solid-state laser light source 200. Specifically, the controller 224 selects an active region 221 to be activated in the first set time T1 within the predetermined operation time Top, out of the active regions 221 of the semiconductor laser array element 236 (semiconductor element 223), and activates the selected active region 221, whereby the harmonic beams 232c and 232e as multi-beams are emitted as the output beams 234c and 234e.

Referring back to FIG. 26, as described above, the controller 224 selects and activates the active regions 221c and 221e (the active regions 241 to be activated in FIG. 27) in the first set time T1 within the predetermined operation time Top; selects and activates the active regions 221a and 221h (the active regions 242 to be activated in FIG. 27) in the second set time T2; selects and activates the active regions 221d and 221f (the active regions 243 to be activated in FIG. 27) in the third set time T3; and thereafter, sequentially selects and activates the active regions in the manner as illustrated. The active regions 241 through 243 to be activated are driven by the power sources 225 and activated in an ON-state during the set time T.

As described above, in this embodiment, two active regions 221 are selected, two beams are outputted as the output beams 234, and the output beams 234 are outputted as multi-beams of the solid-state laser light source 200. Specifically, as shown in FIG. 26, the controller 224 is operable to emit the harmonic beams 232 i.e. multi-beams as the output beams 234 by selecting and activating the active regions to be activated in each of the set times T within the predetermined operation time Top, out of the active regions 221 of the semiconductor laser array elements 236.

As described above, sequentially using each of the active regions 221 of the semiconductor laser array element 236 within the predetermined operation time Top enables to use the semiconductor laser array element 236, without a likelihood that a specific active region 221 may be centrally activated by laser light, a current, an exothermic operation, and the like, and the specific active region 221 may be worn out and deteriorated. Accordingly, the semiconductor laser array element 236 can be used with high fidelity and long life. Similarly, the solid-state laser light source 200 can be used with high fidelity and long life, because the solid-state laser medium 226 and the wavelength converting element 233 are operable to stably emit output light, while avoiding a condition that the temperature of a specific region is increased, and condition that the excitation beams 222 are continuously incident.

Further, as shown in FIG. 26, assuming that any successive set times in the predetermined operation time Top are defined as the first through the third set times T1 through T3, it is obvious that the controller 224 performs a control operation in such a manner that the active regions 221c and 221e selected in the first set time T1 are not selected as active regions (active regions 221a and 221h) to be activated in the second set time T2. Similarly, the controller 224 performs a control operation in such a manner that the active regions 221a and 221h selected in the second set time T2 are not selected as active regions (active regions 221d and 221f) to be activated in the third set time T3. The control operation thereafter is performed in each of the set times in the similar manner as described above.

Also, as shown in FIG. 26, the controller 224 performs a control operation in such a manner that the active regions 221c and 221e selected in the first set time T1, and the active regions 221b, 221d, and 221f adjacent to the active regions 221c and 221e are not selected as active regions (active regions 221a and 221h) to be activated in the second set time T2. Further, the controller 224 performs a control operation in such a manner that the active regions 221a and 221h selected in the second set time T2, and the active regions 221b and 221g adjacent to the active regions 221a and 221h are not selected as active regions (active regions 221d and 221f) to be activated in the third set time T3. Furthermore, the active regions 221b and 221h to be selected in the fourth set time T4 as active regions to be activated are neither the active regions 221d and 221f selected in the third set time T3 preceding the fourth set time T4, nor the active regions 221c, 221e, and 221g adjacent to the active regions 221d and 221f. Similarly, the active regions 221c and 221g to be selected in the N-th set time TN are neither the active regions 221a and 221e selected in the (N−1)-th set time T(N−1) preceding the N-th set time TN, nor the active regions 221b, 221d, and 221f adjacent to the active regions 221a and 221e.

As described above, controlling not to use each of the active regions 221 of the semiconductor laser array element 236 sequentially and adjacently in preceding and succeeding set times is advantageous in using the semiconductor laser array element 236 without a likelihood that a specific active region 221 may be centrally activated by laser light, a current, an exothermic operation, and the like, and that the specific active region 221 may be worn out and deteriorated. Accordingly, the semiconductor laser array element 236 can be used with high fidelity and long life. Similarly, the solid-state laser light source 200 can be used with high fidelity and long life, because the solid-state laser medium 226 and the wavelength converting element 233 are operable to stably emit output light, while avoiding a condition that the temperature of a specific region is increased, and a condition that the excitation beams 222 are continuously incident.

Further, the controller 224 is operable to set the frequency “f” at which the set time T in the predetermined operation time Top is switched to not smaller than 60 Hz and not larger than the relaxation oscillation frequency of the solid-state laser medium 26. This arrangement enables to timewise and orderly switch and use the regions to be used by the respective constituent elements within the range of the frequency at which the solid-state laser light source 200 responds, without causing glare in human eyes. This enables to uniformly and equally use the entirety of the solid-state laser light source 200 within the predetermined operation time Top. Further, since the solid-state laser light source 200 is operated by multi-beams, a high-quality and stable image with reduced speckle noise can be displayed even with use of a laser light source for a display apparatus.

### Tenth Embodiment

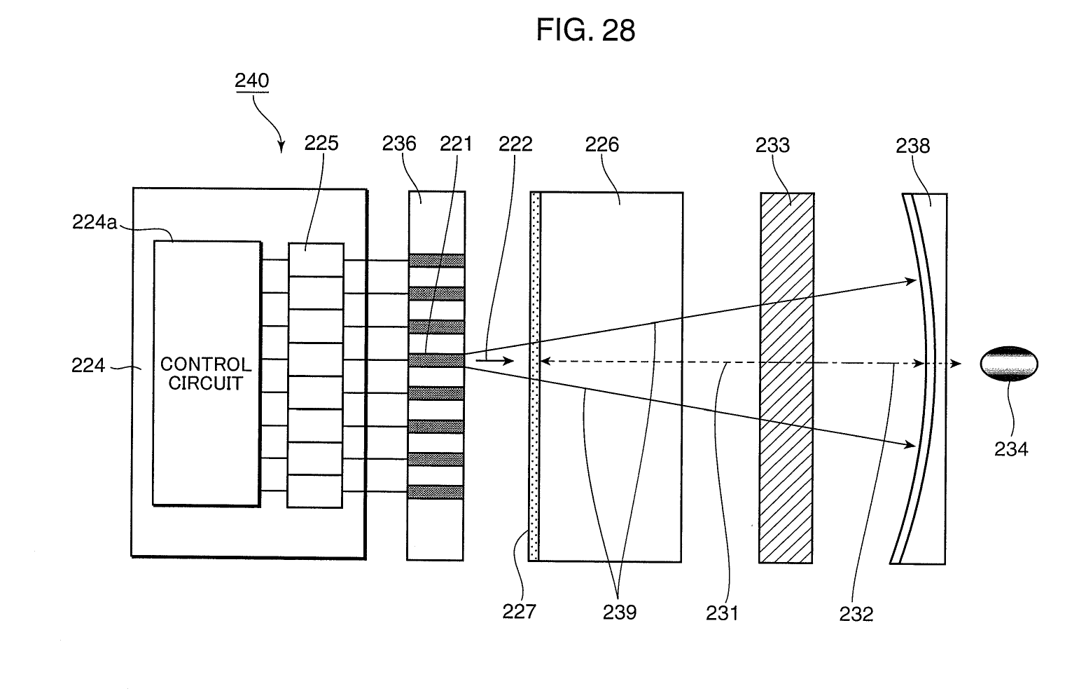

FIG. 28 is a schematic construction diagram showing a solid-state laser light source 240 in accordance with the tenth embodiment of the invention. Unlike the solid-state laser light source 200 shown in FIG. 22, the solid-state laser light source 240 is incorporated with a concave surface mirror 238 in place of the output mirror 228.

In this arrangement, an excitation beam 222 emitted from an active region 221 is not shaped into parallel light by an optical system. Accordingly, even if a beam 239 is diverged as shown in FIG. 28, a fundamental beam 231 can be oscillated by forming a laser resonator of the concave surface mirror 238 and an end surface 227 of a solid-state laser medium 226. A wavelength converting element 233 converts the fundamental beam 231 into a harmonic beam 232, and an output beam 234 is emitted from the concave surface mirror 238. The driving method described in the ninth embodiment, a driving method to be described in the eleventh embodiment to be later, or a like method may be used as a method for driving a semiconductor laser array element 236 in this embodiment.

In this way, in the tenth embodiment, the solid-state laser medium 226 is excited by at least one of the excitation beams 222 from the active regions 221, and the fundamental beams 231 generated from the excited solid-state laser medium 226 are independently and stably subjected to laser oscillation. Accordingly, high-output green laser light in the order of watts can be stably obtained.

### Eleventh Embodiment

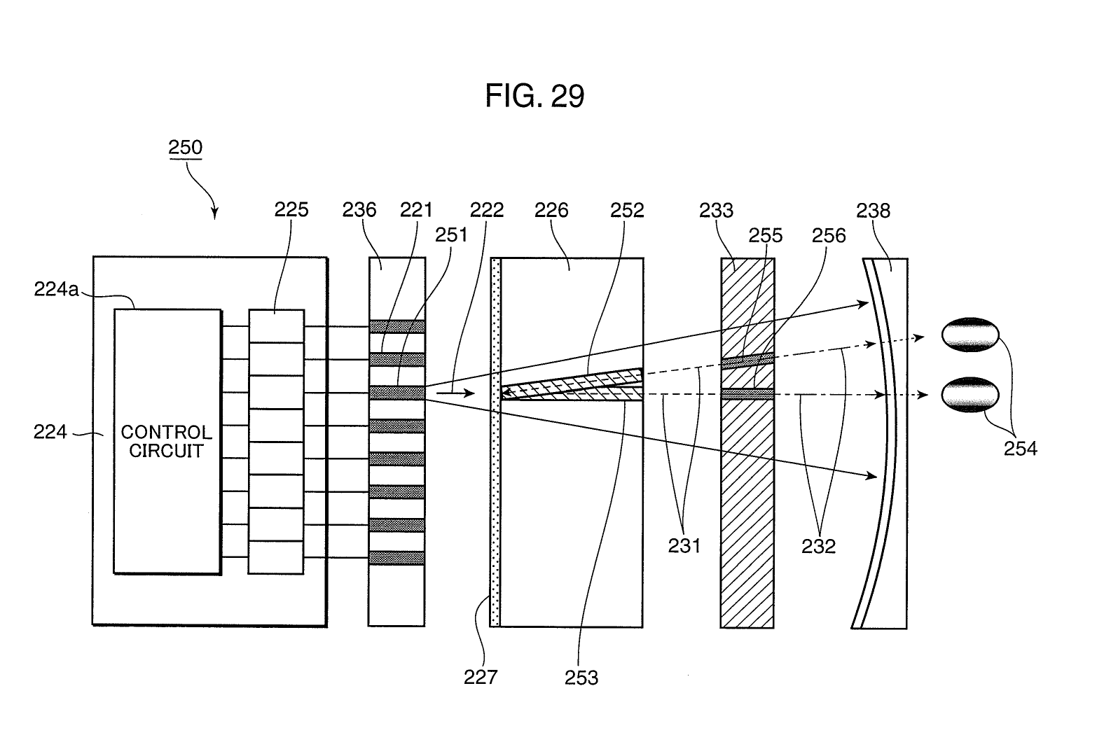

FIG. 29 is a schematic construction diagram showing a solid-state laser light source 250 in accordance with the eleventh embodiment of the invention. In this embodiment, unlike the tenth embodiment, a large-output excitation beam 222 is emitted to excite a solid-state laser medium 226 by applying a current of a large value to one of active regions 221 of a semiconductor laser array element 236, and two generating portions 252 and 253 for generating a fundamental beam 231 are formed in the solid-state laser medium 226. As a result of this operation, a wavelength converting element 233 converts the two fundamental beams 231 into two harmonic beams 232, and output beams 254 as multi-beams are emitted from a concave surface mirror 238.

Specifically, a controller 224 selects one active region 251 to be activated, increases the amount of the excitation beam 222 to be emitted from the selected active region 251 to be activated in each of the set times T within the predetermined operation time Top described in the ninth embodiment to excite the solid-state laser medium 226. Thereby, two or more generating portions 252 and 253 for generating the fundamental beam 231 are formed in the solid-state laser medium 226, and the harmonic beams 232 as multi-beams are emitted as the output beams 254, as shown in FIG. 29.

In this way, selecting the active region 221 different from the active region selected in the preceding set time T, as the active region 251 to be activated for emitting the excitation beam 222 sequentially with respect to each of the set times T enables to use the semiconductor laser array element 236, without a likelihood that a specific active region 221 may be centrally activated by laser light, a current, an exothermic operation, and the like, and the specific active region 221 may be worn out and deteriorated. Accordingly, the semiconductor laser array element 236 can be used with high fidelity and long life.

Further, a region in the solid-state laser medium 226 excited by the excitation beam 222, where a standing wave is generated by a laser resonator constituted of an end surface 227 of the solid-state laser medium 226 and the concave surface mirror 238, is selected as the generating portions 252 and 253 for generating the fundamental beam 231. Since different positions are selected and activated, as the generating portions 252 and 253 and wavelength converting regions 255 and 256 of the wavelength converting element 233 with respect to each of the set times T, there is no likelihood that a specific region may be centrally activated, and the specific region may be worn out and deteriorated by excessive influence of laser light and an exothermic operation.

The solid-state laser light source 250 having the above arrangement is operable to emit the output beams 254 as multi-beams. Accordingly, use of the solid-state laser light source 250 as a light source or the like for a display apparatus by e.g. condensing the two beams is advantageous in displaying a high-quality and stable image with reduced speckle noise.

### Twelfth Embodiment

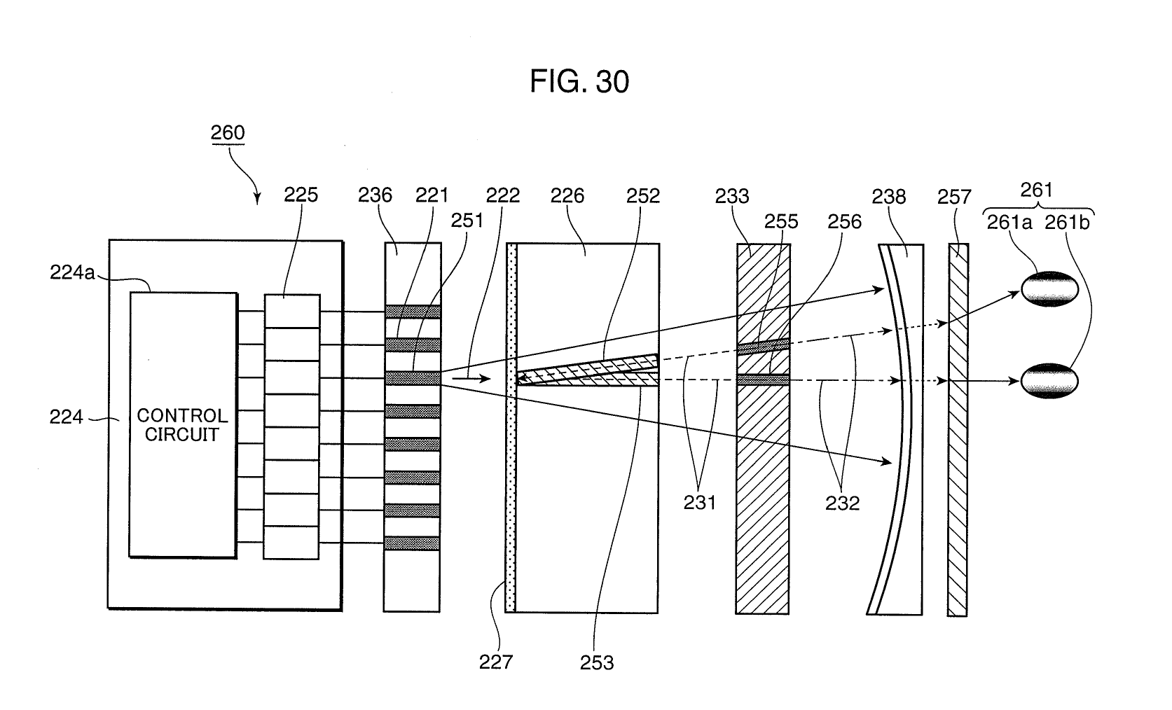

FIG. 30 is a schematic construction diagram showing a solid-state laser light source 260 in accordance with the twelfth embodiment of the invention. As shown in FIG. 30, in this embodiment, a diffraction grating 257 is provided on the exterior of a concave surface mirror 238, in addition to the solid-state laser light source 250 shown in FIG. 29. In this arrangement, output beams 261 are multi-beams constituted of two output beams 261a and 261b, and the exit angle of the multi-beams is increased by the diffraction grating 257. This arrangement enables to further increase the angle of multi-beams to be emitted, which is more advantageous in reducing speckle noise.

### Thirteenth Embodiment

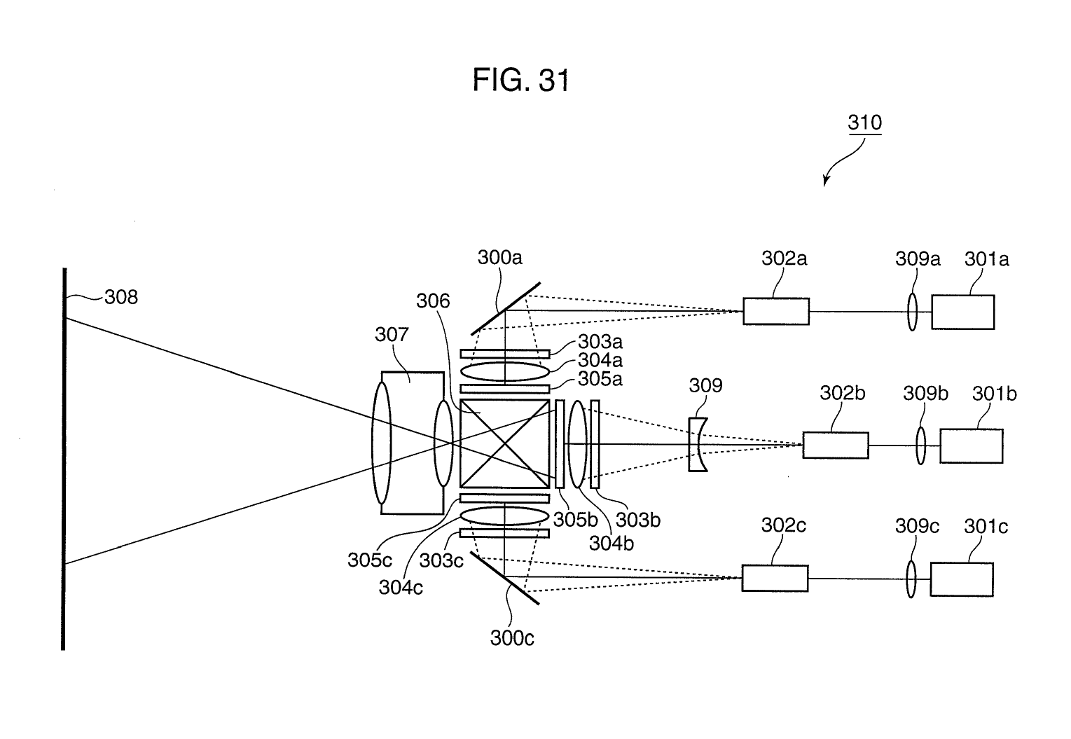

FIG. 31 is a schematic construction diagram showing an example of an arrangement of an image display apparatus incorporated with one of the solid-state laser light sources described in the ninth through the twelfth embodiments, as the thirteenth embodiment of the invention. As shown in FIG. 31, an image display apparatus 310 in this embodiment includes laser light sources 301a, 301b, and 301c; and scanning portions 302a, 302b, and 302c for scanning the laser light sources 301a, 301b, and 301c.

The laser light sources 301a, 301b, and 301c are respectively light sources for emitting at least red light (R light), green light (G light), and blue light (B light). The red laser light source (R light source) 301a is a semiconductor laser apparatus composed of AlGaInP/GaAs-based material for emitting laser light of 640 nm wavelength. The blue laser light source (B light source) 301c is a semiconductor laser apparatus composed of GaN-based material for emitting laser light of 450 nm wavelength. The green laser light source (G light source) 301b is one of the solid-state laser light sources for emitting laser light of 532 nm wavelength in accordance with the ninth through the twelfth embodiments.

Next, an optical arrangement of the image display apparatus 310 in this embodiment is described. Laser beams emitted from the light sources 301a, 301b, and 301c of the image display apparatus 301 are condensed by condenser lenses 309a, 309b, and 309c, scanned by the reflective two-dimensional beam scanners 302a, 302b, and 302c constituting a scanning section, and scanned on diffusers 303a, 303b, and 30c via a mirror 300a, a concave lens 309, and a mirror 300c.

The laser beams transmitted through the diffusers 303a, 303b, and 303c are converged by field lenses 304a, 304b, and 304c, and guided to spatial light modulators 305a, 305b, and 305c. Image data is divided into R data, G data, and B data. Signals of the RGB data are inputted to the spatial light modulators 305a, 305b, and 305c, and the laser beams subjected to modulation by the spatial light modulators 305a, 305b, and 305c are combined by a dichroic prism 306, whereby a color image is formed. The color image is projected onto a screen 308 through a projection lens 307.

A concave lens 309 is provided on the optical path from the G light source 301b to the spatial light modulator 305b to make the spot size of G light through the spatial light modulator 305b identical to that of R light and B light. The G light source 301b is constructed to easily scanned by the reflective two-dimensional scanner 302b by adding an optical component such as a condenser lens (not shown) to one of the solid-state laser light sources described in the ninth through the twelfth embodiments to condense output beams as multi-beams.

In the image display apparatus 310 in this embodiment, one of the solid-state laser apparatuses described in the ninth through the twelfth embodiments is used as the G light source 301b. Accordingly, a high-quality and stable image with reduced speckle noise can be displayed, and the long-life and high-fidelity image display apparatus 310 can be realized.

It is preferable to apply a system for timewise oscillating a lenticular lens or a micro lens array, as a driving system for the reflective two-dimensional beam scanners 302a, 302b, and 302c. In the case of multi-beams, if an intensity distribution of beams appears on a screen, an intensity distribution is generated in the screen, which may affect an image to be displayed. Also, if a beam is oscillated in one direction, black streaks appear, which deteriorates the image quality. As a measure for preventing these drawbacks, there is proposed an arrangement of combining multi-beams to be emitted from one of the solid-state laser apparatuses described in the ninth through the twelfth embodiments, and a lenticular lens or a micro lens array.

In the above arrangement, it is desirable to differentiate the frequency for scanning the beams by the reflective two-dimensional bean scanners 302a, 302b, and 302c from the frequency at which the emission position of the semiconductor element 223 (see FIG. 22) is timewise changed. If the frequency for beam scanning, and the frequency at which the emission position of the semiconductor element 223 is changed are synchronized, a change in beams is recognized, a noise is superimposed on an image, and a screen is deteriorated. However, complicated beam movement can be realized, and speckle noise can be further reduced by differentiating the frequencies from each other.

In the case where a multi-beam light source is used, a dark portion may appear on overlapping portions of beams resulting from interference. However, use of a lenticular lens or a micro lens array makes a dark portion invisible, and enhances the image quality, because the beams are divided into multiple beams. Preferably, the size of a lens of the micro lens array is set smaller than the size of multi-beams on the micro lens array. This enables to enhance uniformity of projection light, and make the intensity distribution of beams by multi-beam configuration uniform.

### Fourteenth Embodiment

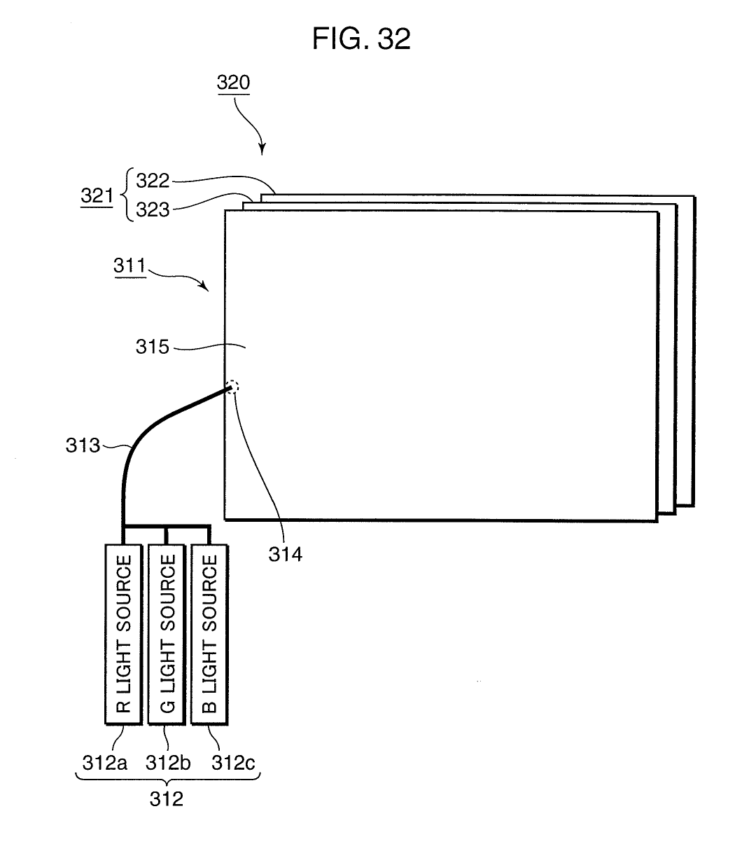

FIG. 32 is a schematic construction diagram of a liquid crystal display apparatus 320 incorporated with a backlight illumination device including one of the solid-state laser light sources described in the ninth through the twelfth embodiments, as the fourteenth embodiment of the invention. As shown in FIG. 32, the liquid crystal display apparatus 320 is constituted of a liquid crystal display panel 321, and a backlight illumination device 311 for illuminating the liquid crystal display panel 321 from the rear side thereof.

The backlight illumination device 311 is constituted of a laser light source unit 312, an optical fiber 313 for guiding a bundle of laser light of R light, G light, and B light from the laser light source unit 312 to a light guiding plate 315 through a light guiding portion 314, and the light guiding plate 315 having a primary plane (not shown) where the laser light of R light, G light, and B light uniformly resides to emit the laser light. The liquid crystal display panel 321 is constituted of a polarization plate 322 and a liquid crystal plate 323 for displaying an image by utilizing the laser light of R light, G light, and B light to be emitted from the backlight illumination device 311

The laser light source unit 312 is constituted of an R light source 312a, a G light source 312b, and a B light source 312c for emitting at least red light, green light, and blue light, respectively. The R light source 312a, the G light source 312b, and the B light source 312c respectively emit laser light of red, green, and blue. Out of the laser light source unit 312, the G light source 312b is constituted of one of the solid-state laser light sources described in the ninth through the twelfth embodiments.

A semiconductor laser apparatus composed of AlGaInP/GaAs-based material for emitting laser light of 640 nm wavelength is used as the R light source 312a. A semiconductor laser apparatus composed of GaN-based material for emitting laser light of 450 nm wavelength is used as the B light source 312c. One of the solid-state laser light sources for emitting laser light of 532 nm wavelength described in the ninth through the twelfth embodiments is used as the G light source 312b. The G light source 312b is additionally provided with an optical component such as a condenser lens (not shown) to one of the solid-state laser light sources described in the ninth to the twelfth embodiments to condense output beams as multi-beams through the optical fiber 313 and guide the output beams to the light guiding plate 315.

Preferably, the optical fiber 313 is a multi-mode fiber. This arrangement enables to change a beam pattern of light to be incident into the light guiding portion 314 and reduce speckle noise, when the oscillation mode of the solid-state laser light source as the G light source 312b is timewise changed. An exit beam from a multi-mode green laser is timewise changed. Accordingly, it is necessary to set the core diameter of the optical fiber to 500 μm or more to reduce connection loss with the fiber.

As described above, in the liquid crystal display apparatus 320 in this embodiment, since one of the solid-state laser light sources described in the ninth through the twelfth embodiments is used as the G light source 312b, a high-quality and stable image with reduced speckle noise can be displayed, and a long-life and high-fidelity image display apparatus can be realized.

### Fifteenth Embodiment

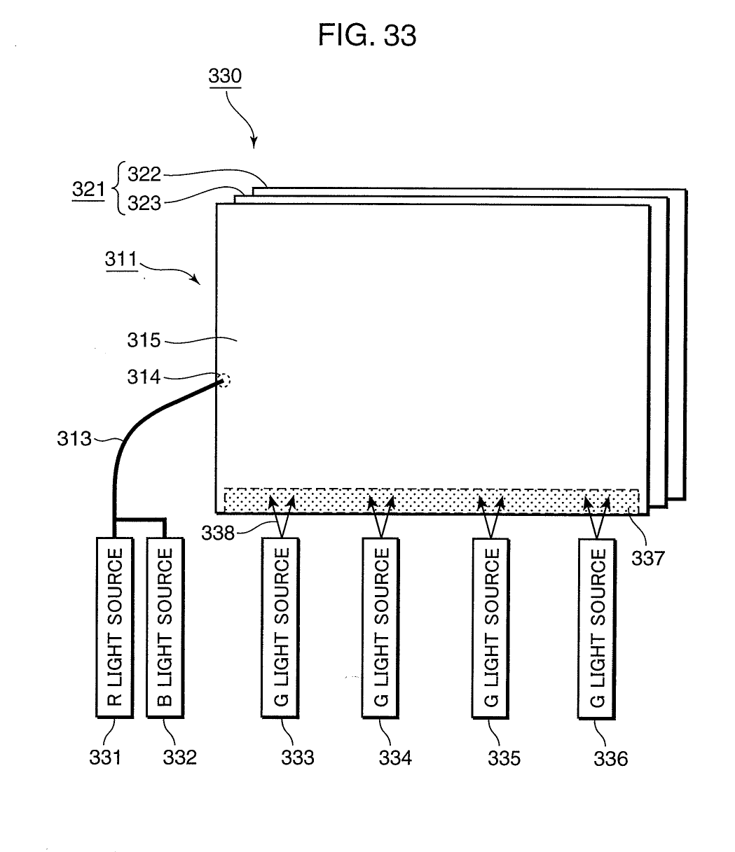

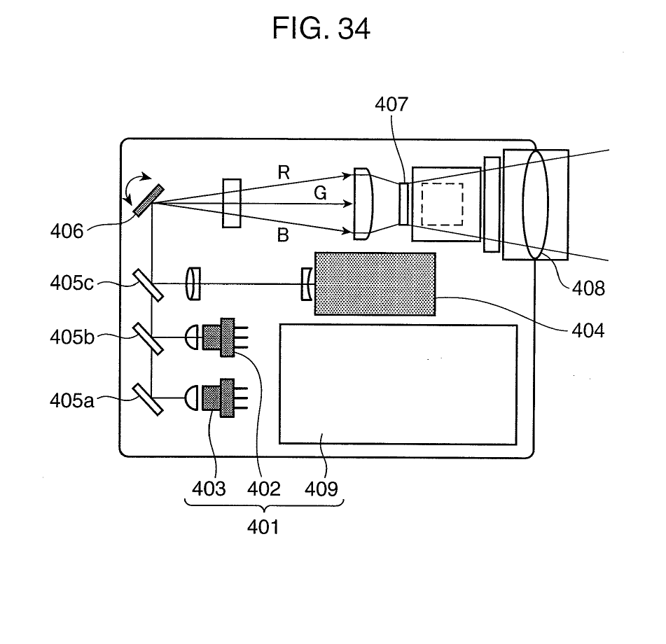

FIG. 33 is a schematic construction diagram of a liquid crystal display apparatus 330 incorporated with a backlight illumination device including one of the solid-state laser light sources described in the ninth through the twelfth embodiments, as the fifteenth embodiment of the invention.

An R light source 331 and a B light source 332 substantially identical to those shown in FIG. 32 are arranged as a red laser light source and a blue laser light source in a backlight illumination device 311 to allow incidence of red laser light and blue laser light onto a light guiding plate 315 by an optical fiber 313 through a light guiding portion 314.

In this embodiment, solid-state laser light sources 333, 334, 335, and 336 are arranged on the rear surface of a liquid crystal display panel 321, as G light sources. The solid-state laser light source 333, 3334, 335, 336 is constituted of one of the solid-state laser light sources described in the ninth through the twelfth embodiments. Output beams 338 as multi-beams from the solid-state laser light sources 333, 334, 335, and 336 are directly irradiated to a light guiding portion 337 of the light guiding plate 315 disposed on the rear surface of the liquid crystal display panel 321, thereby allowing incidence of green laser light onto the light guiding plate 315.

The solid-state laser light sources 333, 334, 335, and 336 may be made of solid-state laser media different from each other. For instance, the solid-state laser light sources 333, 334, 335, and 336 made of different media such as Nd:YVO₄, Nd:GdVO₄, Nd:YLF, and ND:YAG may be arranged side by side. Further alternatively, the wavelengths of harmonic beams as output beams of adjacent solid-state laser light sources out of the solid-state laser light sources 333, 334, 335, and 336 may be different from each other in the range of not smaller than 1 nm and not larger than 20 nm.

The above arrangement enables to further reduce speckle noise resulting from green laser light. Alternatively, solid-state laser light sources having different wavelengths of harmonic beams may be alternately arranged to suppress color variation as a whole.

The above arrangement in this embodiment enables to realize a long-life and high-fidelity image display apparatus capable of displaying a high-quality and stable image with reduced speckle noise, and also enables to display a clear green image with less color variation.

In this embodiment, since the solid-state laser light sources 333, 334, 335, and 336 are capable of timewise changing beams to be generated, the beams are timewise changed, and speckle noise can be remarkably reduced in guiding the beams to the light guiding plate 315. Also, diffusing the beams in the interior of the light guiding plate 315 increases the effect of reducing speckle noise. Furthermore, regarding variation in intensity distribution of beams by multi-beams, the intensity distribution can be made uniform by diffusing the beams in the interior of the light guiding plate 315.

A method for timewise changing a propagation path of laser beams is used, as a normal method for reducing speckle noise. This requires a mechanical driver for scanning a beam or scanning a diffuser. On the other hand, in this embodiment, the beam shape of multi-beams to be generated from the solid-state laser light sources 333, 334, 335, and 336 can be timewise changed by timewise changing the emission point of a semiconductor element for exciting a solid-state laser medium, thereby enabling to remarkably reduce speckle noise. Consequently, in this embodiment, since a mechanical drive is not required, a high-fidelity image display apparatus can be realized. The arrangements of the aforementioned embodiments may be optionally combined to each other. The modifications are also advantageous in obtaining substantially the same effect as described above.

The following is a summary of the embodiments of the invention. Specifically, a solid-state laser apparatus according to an aspect of the invention includes: a semiconductor laser light source for emitting laser light; an optical resonator including a solid-state laser medium to be excited by incidence of the laser light to oscillate fundamental laser light, and a mirror; and a quasi phase matching wavelength converting element, disposed in the optical resonator, for converting a wavelength of the fundamental laser light, wherein the quasi phase matching wavelength converting element is formed with a polarization inversion region having a predetermined cycle, and the length of the polarization inversion region in an optical axis direction is 1.0 mm or less.

In the solid-state laser apparatus, large-output and wavelength-stable laser light can be outputted in an increased allowable temperature range, and without precise temperature control. In the case where the solid-state laser apparatus is used in a display apparatus, a compact and low-cost apparatus can be realized.

Preferably, the length of the quasi phase matching wavelength converting element formed with the polarization inversion region in the optical axis direction may be not less than 0.3 mm and not more than 0.6 mm.

In the above arrangement, since a high-output operation can be performed, and the allowable temperature range can be increased, a low-cost and large-output solid-state laser apparatus can be realized. Also, since the element length of the quasi phase matching wavelength converting element is short, the allowable range of wavelength conversion characteristic can be increased, and the wavelength bandwidth of laser light can be increased, which is advantageous in reducing speckle noise.

Preferably, the polarization inversion region may include a first polarization inversion region having a first cycle, and a second polarization inversion region having a second cycle shorter than the first cycle, and the length of the second polarization inversion region may be shorter than the length of the first polarization inversion region. In this arrangement, preferably, the length of the quasi phase matching wavelength converting element formed with the first polarization inversion region and the second polarization inversion region in the optical axis direction may be 1.2 mm or less, and the length of the first polarization inversion region in the optical axis direction may be not less than 0.1 mm and not more than 0.2 mm, and the length of the second polarization inversion region in the optical axis direction may be not less than 0.3 mm and not more than 1.0 mm.

In the above arrangement, the degree of allowance with respect to a temperature of the first polarization inversion region is increased, as compared with that of the second polarization inversion region; and wavelength conversion efficiency of the first polarization inversion region in a low temperature condition is increased, as compared with that of the second polarization inversion region. Accordingly, the allowable temperature range can be increased, and a start-up time of the apparatus can be reduced, even in a condition that the usage environment temperature in starting up the apparatus is low.

Preferably, the solid-state laser apparatus may further include a heating device, disposed near the quasi phase matching converting element, for heating the quasi phase matching wavelength converting element.

In the above arrangement, since the quasi phase matching wavelength converting element can be heated, a startup time in driving and starting up the apparatus from an environment temperature lower than the reference control temperature can be reduced, and the temperature of the quasi phase matching wavelength converting element can rapidly reach the reference control temperature. This is advantageous in stably driving the apparatus in starting up the apparatus.

Preferably, the heating device may be an electric heater. In this arrangement, use of the electric heater enables to reduce the cost of the apparatus, and set the temperature of the quasi phase matching wavelength converting element to the reference control temperature or higher in a short time.

Preferably, the heating device may be an ultraviolet light source. In this arrangement, since ultraviolet light emitted from the ultraviolet light source is absorbed by the quasi phase matching wavelength converting element, and converted into heat, the heating device assists in increasing the temperature of the quasi phase matching wavelength converting element, in the case where the usage environment temperature in starting up the apparatus is low.

Preferably, the solid-state laser apparatus may further include a control circuit for supplying a maximum rated current to the semiconductor laser light source to control a startup operation of the semiconductor laser light source, in the case where a temperature of the quasi phase matching wavelength converting element is lower than a reference control temperature.

In the above arrangement, since the temperature of the semiconductor laser light source can be rapidly increased, a startup time in driving and starting up the apparatus from an environment temperature lower than the reference control temperature can be reduced, and the temperature of the quasi phase matching wavelength converting element is allowed to rapidly reach the reference control temperature. Accordingly, the apparatus can be stably driven in starting up the apparatus.

Preferably, the mirror may be disposed with an inclination of 45 degrees with respect to a light incident surface of the solid-state laser medium and a light incident surface of the quasi phase matching wavelength converting element, the laser light may be incident into the solid-state laser medium via the mirror, the fundamental laser light may be incident into the quasi phase matching wavelength converting element via the mirror, and harmonic laser light converted by the quasi phase matching wavelength converting element may be emitted via the mirror.

The above arrangement not only enables to cool the solid-state laser medium and the quasi phase matching wavelength converting element by sufficiently large heat sinks, but also enables to effectively dissipate the heat in a region of the quasi phase matching wavelength converting element, where heat is likely to generated. Thereby, variation in laser output resulting from heat generation can be suppressed, without performing precise temperature control using a Peltier element or a like element.

Preferably, the solid-state laser medium and the quasi phase matching wavelength converting element may be fixed to heat sinks, respectively.

In the above arrangement, the solid-state laser medium and the quasi phase matching wavelength converting element can be cooled by the sufficiently large heat sinks, individually.

Preferably, the solid-state laser apparatus may further include an oscillation wavelength fixing portion for fixing an oscillation wavelength of the laser light.

In the above arrangement, even if the environment temperature is changed, the oscillation wavelength of the semiconductor laser light source can be kept substantially constantly. This eliminates the need of high-precision temperature control with respect to the semiconductor laser light source. An example of the oscillation wavelength fixing portion is a transparent diffraction grating i.e. VBG (Volume Bragg Grating). In this example, laser light emitted from the semiconductor laser light source is incident into the VBG, a part of the laser light is reflected on the VBG, and fed back to the semiconductor laser light source. Thus, the oscillation wavelength of the semiconductor laser light source is fixed to a wavelength selected by the VBG.

Preferably, the semiconductor laser light source may include a semiconductor element for emitting excitation light from active regions, the solid-state laser apparatus may further include a controller for controlling the excitation light by driving the active regions of the semiconductor element independently of each other, and the controller may be operable to timewise change a position of a generating portion for generating the fundamental laser light of the solid-state laser medium to be excited by the excitation light to cause the quasi phase matching wavelength converting element to emit harmonic laser light as multi-beams by selectively driving one of the active regions.

In the above arrangement, since high-output green laser light in the order of watts can be stably obtained, a long-life and high-fidelity solid-state laser light source can be realized. Also, displaying an image with use of the solid-state laser apparatus enables to emit harmonic laser light as multi-beams. This is advantageous in displaying an image with reduced speckle noise.

Preferably, the semiconductor element may be a semiconductor laser array element having the active regions operable to be driven independently of each other. This arrangement also enables to stably obtain high-output green laser light in the order of watts.

Preferably, the semiconductor element may include plural semiconductor laser elements, arranged in parallel to each other, for emitting the excitation light from the respective active regions. This arrangement also enables to stably obtain high-output green laser light in the order of watts.

Preferably, the polarization inversion region may have portions whose phases of cycles are different from each other. In this arrangement, since multi-beams are generated by interference between beams, and the sectional area of beams can be increased, the power density of harmonic light can be reduced, resistance against high output can be increased, and the interference degree can be lowered by turning the harmonic laser light into a multi mode beam. This enables to stably obtain high-output green laser light in the order of watts.

Preferably, the mirror may be a concave surface mirror. In this arrangement, fundamental laser light to be generated from the solid-state laser medium excited by excitation light from the active regions can be individually and stably subjected to laser oscillation.

Preferably, the controller may cause the active region to emit the harmonic laser light as the multi-beams by selectively driving the active region to be activated in each of set times defined in a predetermined operation time out the active regions.

In the above arrangement, sequentially using each of the active regions of the semiconductor element in the predetermined operation time enables to use the semiconductor element, without a likelihood that a specific active region may be centrally activated by laser light, a current, an exothermic operation, and the like, and the specific active region may be worn out and deteriorated. This enables to use the semiconductor element with high fidelity and long life.

Preferably, the controller may be operable to generate two or more of the generating portions for generating the fundamental laser light in the solid-state laser medium to cause the generating portions to emit the harmonic laser light as the multi-beams by selecting one of the active regions as the active region to be activated, and exciting the solid-state laser medium by increasing the excitation light to be emitted from the selected active region.

In the above arrangement, sequentially using one of the active regions of the semiconductor element in the predetermined operation time enables to use the semiconductor element, without a likelihood that a specific active region may be centrally activated by laser light, a current, an exothermic operation, and the like, and the specific active region may be worn out and deteriorated. This enables to use the semiconductor element with high fidelity and long life.

Assuming that any successive set times out of the set times are defined as a first set time and a second set time, preferably, the controller may be operable to drive the active regions in such a manner that the active region selected in the first set time is not selected as the active region to be activated in the second set time.

In the above arrangement, sequentially using each of the active regions of the semiconductor element in the predetermined operation time in such a manner that the active region selected in the first set time is not selected as the active region to be activated in the second set time enables to use the semiconductor element, without a likelihood that a specific region may be centrally activated, and the specific region may be worn out and deteriorated by excessive influence of laser light, an exothermic operation, and the like. This enables to use the semiconductor element with high fidelity and long life.

Assuming that any successive set times out of the set times are defined as a first set time and a second set time, preferably, the controller may be operable to drive the active regions in such a manner that the active region selected in the first set time and the active region adjacent to the selected active region are not selected as the active region to be activated in the second set time.

In the above arrangement, sequentially using each of the active regions of the semiconductor element in the predetermined operation time in such a manner that the active region selected in the first set time and the active region adjacent to the selected active region are not selected as the active region to be activated in the second set time enables to further reduce an influence resulting from heat transfer from the adjacent active region.

Preferably, a frequency at which the set time is switched may not less than 60 Hz and not more than a relaxation oscillation frequency of the solid-state laser medium.

In the above arrangement, even in use of the solid-state laser apparatus as a laser light source in an image display apparatus, a high-quality and stable image with reduced speckle noise can be displayed.

Preferably, the solid-state laser apparatus may further include a diffraction grating disposed on an exterior of the mirror. In this arrangement, since the angle of multi-beams to be emitted can be further increased, speckle noise can be further advantageously reduced.

A display apparatus according to another aspect of the invention includes: an image converting device; and an illumination light source for irradiating the image converting device, wherein the illumination light source includes a red light source, a green light source, and a blue light source, and at least one of the red light source, the green light source, and the blue light source is constituted of the solid-state laser apparatus recited in any one of the above arrangements.

In the display apparatus, since the compact and large-output illumination light source is used, the entirety of the display apparatus can be miniaturized. Further, since the laser light source is used, color reproducibility can be further enhanced, as compared with the conventional art.

Preferably, the image converting device may include a two-dimensional space modulation device, and the illumination light source may be operable to irradiate the two-dimensional space modulation device by combining the laser lights emitted from the red light source, the green light source, and the blue light source. This arrangement enables to minimize the number of two-dimensional space modulation devices, thereby reducing the cost of the display apparatus.

Preferably, the image converting device may include three transparent liquid crystal display panels, the transparent liquid crystal display panels may be arranged in correspondence to the laser light to be emitted from the red light source, the green light source, and the blue light source, respectively, and image lights transmitted through the transparent liquid crystal display panels may be combined by a combination prism for projection. This arrangement enables to display a high-precision image with use of the transparent liquid crystal display panel provided for each of the light sources.

A display apparatus according to yet another aspect of the invention includes: a liquid crystal display panel; and a backlight illumination device for illuminating the liquid crystal display panel from a rear side of the liquid crystal display panel, wherein the backlight illumination device includes laser light sources, the laser light sources have a red light source, a green light source, and a blue light source, and the green light source is constituted of the solid-state laser apparatus recited in any one of the above arrangements

Use of the display apparatus enables to realize a long-life and high-fidelity image display apparatus capable of displaying a high-quality and stable image with reduced speckle noise.

Preferably, a plurality of the solid-state laser apparatuses may be arranged on the rear side of the liquid crystal display panel. This arrangement is more advantageous in displaying a high-quality and stable image with reduced speckle noise.

Preferably, in the solid-state laser apparatuses, wavelengths of harmonic laser light from the solid-state laser apparatuses adjacent to each other may be different from each other in the range from not less than 1 nm to not more than 20 nm. This arrangement enables to display a clear green image with less color variation.

Preferably, the display apparatus may further include a heat transfer portion, disposed near the quasi phase matching wavelength converting element, for transferring a heat from a heat generating portion in the display apparatus to the quasi phase matching wavelength converting element.

In the above arrangement, the heat in the heat generating portion can be transferred to the quasi phase matching wavelength converting element to heat the quasi phase matching wavelength converting element. This enables to reduce a startup time in driving and starting up the apparatus from an environment temperature lower than the reference control temperature, and allows the temperature of the quasi phase matching wavelength converting element to rapidly reach the reference control temperature. This is advantageous in stably driving the apparatus in starting up the apparatus.

Preferably, the heat generating portion may be at least one of the red light source and the blue light source. In this arrangement, since the red light source and the blue light source can be used in common as a heat transfer portion, a compact and low-cost apparatus can be realized.

A wavelength converting element according to still another aspect of the invention is a quasi phase matching wavelength converting element, disposed in an optical resonator including a solid-state laser medium to be excited by incidence of laser light from a semiconductor laser light source to oscillate fundamental laser light, and a minor. The quasi phase matching wavelength converting element is adapted to convert a wavelength of the fundamental laser light, wherein the quasi phase matching wavelength converting element is formed with a polarization inversion region having a predetermined cycle, and the length of the polarization inversion region in an optical axis direction is 1.0 mm or less.

In the wavelength converting element, large-output fundamental laser light can be inputted from the solid-state laser medium, and a temperature-stable and high-output solid-state laser apparatus can be realized by improved conversion efficiency and an increase in the allowable temperature range.

### INDUSTRIAL APPLICABILITY

According to the inventive solid-state laser apparatus, the allowable temperature range can be increased. Accordingly, large-output and wavelength-stable laser light can be outputted without fine temperature control. This is useful in the field of display apparatuses such as a projection display apparatus.

The invention also enables to provide a long-life and high-fidelity solid-state laser apparatus for outputting high-output green laser light in the order of watts with reduced speckle noise, as well as a high-quality display apparatus incorporated with the solid-state laser apparatus, and accordingly is useful in display devices such as a large-sized display apparatus and a high-luminance display apparatus, or an illumination device.

1-32. (canceled)

33. A solid-state laser apparatus comprising:
a semiconductor laser light source for emitting laser light;
an optical resonator including a solid-state laser medium to be excited by incidence of the laser light to oscillate fundamental laser light, and a mirror; and
a quasi phase matching wavelength converting element, disposed in the optical resonator, for converting a wavelength of the fundamental laser light, wherein
the quasi phase matching wavelength converting element is formed with a polarization inversion region having a predetermined cycle,
the polarization inversion region includes at least
a first polarization inversion region having a first cycle, and
a second polarization inversion region having a second cycle shorter than the first cycle,
the length of the second polarization inversion region is longer than the length of the first polarization inversion region, and
the first polarization inversion region and the second polarization inversion region have an overlapping portion in a temperature range where quasi phase matching is to be performed, and are operable to continuously perform wavelength conversion with respect to a temperature in the temperature range.

34. The solid-state laser apparatus according to claim 33, wherein
the length of the quasi phase matching wavelength converting element formed with the first polarization inversion region and the second polarization inversion region in an optical axis direction is 1.2 mm or less.

35. The solid-state laser apparatus according to claim 34, wherein
the length of the first polarization inversion region in the optical axis direction is not less than 0.1 mm and not more than 0.2 mm, and
the length of the second polarization inversion region in the optical axis direction is not less than 0.3 mm and not more than 1.0 mm.

36. The solid-state laser apparatus according to claim 33, wherein
the semiconductor laser light source includes a semiconductor element for emitting excitation light from active regions,
the solid-state laser apparatus further includes a controller for controlling the excitation light by driving the active regions of the semiconductor element independently of each other,
the controller is operable to timewise change a position of a generating portion for generating the fundamental laser light of the solid-state laser medium to be excited by the excitation light to cause the quasi phase matching wavelength converting element to emit harmonic laser light as multi-beams by selectively driving one of the active regions, and
the polarization inversion region has portions whose phases of cycles are different from each other.

37. The solid-state laser apparatus according to claim 36, wherein
the controller causes the active region to emit the harmonic laser light as the multi-beams by selectively driving the active region to be activated in each of set times defined in a predetermined operation time out the active regions, and
assuming that any successive set times out of the set times are defined as a first set time and a second set time, the controller is operable to drive the active regions in such a manner that the active region selected in the first set time and the active region adjacent to the selected active region are not selected as the active region to be activated in the second set time.

38. A display apparatus comprising:
an image converting device; and
an illumination light source for irradiating the image converting device, wherein
the illumination light source includes a red light source, a green light source, and a blue light source, and
at least one of the red light source, the green light source, and the blue light source is the solid-state laser apparatus recited in claim 33.

39. The display apparatus according to claim 38, wherein
the image converting device includes a two-dimensional space modulation device, and
the illumination light source is operable to irradiate the two-dimensional space modulation device by combining the laser lights emitted from the red light source, the green light source, and the blue light source.

40. The display apparatus according to claim 38, wherein
the image converting device includes three transparent liquid crystal display panels,
the transparent liquid crystal display panels are arranged in correspondence to the laser light to be emitted from the red light source, the green light source, and the blue light source, respectively, and
image lights transmitted through the transparent liquid crystal display panels are combined by a combination prism for projection.

41. A display apparatus comprising:
a liquid crystal display panel; and
a backlight illumination device for illuminating the liquid crystal display panel from a rear side of the liquid crystal display panel, wherein
the backlight illumination device includes laser light sources,
the laser light sources have a red light source, a green light source, and a blue light source, and
the green light source is constituted of the solid-state laser apparatus recited in claim 33.

42. The display apparatus according to claim 41, wherein
a plurality of the solid-state laser apparatuses are arranged on the rear side of the liquid crystal display panel.

43. The display apparatus according to claim 42, wherein
in the solid-state laser apparatuses, wavelengths of harmonic laser light from the solid-state laser apparatuses adjacent to each other are different from each other in the range from not less than 1 nm to not more than 20 nm.

44. A quasi phase matching wavelength converting element, disposed in an optical resonator including a solid-state laser medium to be excited by incidence of laser light from a semiconductor laser light source to oscillate fundamental laser light, and a mirror, the quasi phase matching wavelength converting element adapted to convert a wavelength of the fundamental laser light, wherein
the quasi phase matching wavelength converting element is formed with a polarization inversion region having a predetermined cycle,
the polarization inversion region includes
a first polarization inversion region having a first cycle, and
a second polarization inversion region having a second cycle shorter than the first cycle,
the length of the second polarization inversion region is longer than the length of the first polarization inversion region, and
the first polarization inversion region and the second polarization inversion region have an overlapping portion in a temperature range where quasi phase matching is to be performed, and are operable to continuously perform wavelength conversion with respect to a temperature in the temperature range.
